(19) United States
(12) Patent Application Publication
(10) Pub. No.: US 2018/0359149 A1
(43) Pub. Date: Dec. 13, 2018

(54) SYSTEMS AND METHODS FOR ADDING AND MODIFYING SIGNALING RADIO BEARERS AND DATA RADIO BEARERS THAT INCLUDE NUMEROLOGY (SUB-CARRIER SPACING) INFORMATION

(71) Applicant: Sharp Laboratories of America, Inc., Camas, WA (US)

(72) Inventor: Kamel M. Shaheen, Camas, WA (US)

(21) Appl. No.: 16/002,176

(22) Filed: Jun. 7, 2018

Related U.S. Application Data
(63) Continuation of application No. PCT/US2018/036235, filed on Jun. 6, 2018.
(60) Provisional application No. 62/517,068, filed on Jun. 8, 2017.

(51) Int. Cl. H04L 12/24; H04W 76/27; H04W 72/04

(52) U.S. Cl. CPC H04L 41/0813; H04W 76/27; H04W 88/02; H04W 72/0406; H04W 72/0453

(57) ABSTRACT

A user equipment (UE) is described. The UE includes a processor and memory in electronic communication with the processor. Instructions stored in the memory are executable to receive system information comprising information elements (IEs) of a list and/or instances for allowed/supported numerologies (sub-carrier spacing) in a cell for uplink (UL) frequencies and downlink (DL) frequencies. The IEs are received over dedicated RRC signaling and/or broadcast signaling. The instructions are also executable to configure or reconfigure the UE to send and receive packets using the allowed/supported numerologies (sub-carrier spacing).

### RELATED APPLICATIONS

This application is related to and claims priority from U.S. Provisional Patent Application No. 62/517,068, entitled “SYSTEMS AND METHODS FOR ADDING AND MODIFYING SIGNALING RADIO BEARERS AND DATA RADIO BEARERS THAT INCLUDE NUMEROLOGY INFORMATION,” filed on Jun. 8, 2017, which is hereby incorporated by reference herein, in its entirety.

### TECHNICAL FIELD

The present disclosure relates generally to communication systems. More specifically, the present disclosure relates to systems and methods for adding and modifying signaling radio bearers (SRBs) and data radio bearers (DRBs) including numerology (sub-carrier spacing) information in Long Term Evolution (LTE) and 5G new radio (NR).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more base stations (gNBs) and one or more user equipments (UEs) in which systems and methods for adding and modifying signaling radio bearers (SRBs) and data radio bearers (DRBs) that include numerology (sub-carrier spacing) information may be implemented;

FIG. 2 illustrates an example of a successful Radio Resource Control (RRC) connection establishment procedure;

FIG. 3 illustrates an example of a network rejection in a RRC connection establishment procedure;

FIG. 4 illustrates an example of a successful RRC connection resume procedure;

FIG. 5 illustrates an example of a successful RRC connection resume fallback to RRC connection establishment procedure;

FIG. 6 illustrates an example of a network rejection or release in a RRC connection resume procedure;

FIG. 7 illustrates an example of a successful RRC connection reconfiguration procedure;

FIG. 8 illustrates an example of a failure in a RRC connection reconfiguration procedure;

FIG. 9 is a block diagram illustrating one implementation of a gNB;

FIG. 10 is a block diagram illustrating one implementation of a UE;

FIG. 11 illustrates various components that may be utilized in a UE;

FIG. 12 illustrates various components that may be utilized in a gNB;

FIG. 13 is a block diagram illustrating one implementation of a UE in which systems and methods for adding and modifying SRBs and DRBs that include numerology (sub-carrier spacing) information may be implemented;

FIG. 14 is a block diagram illustrating one implementation of a gNB in which systems and methods for adding and modifying SRBs and DRBs that include numerology (sub-carrier spacing) information may be implemented;

FIG. 15 is a flow diagram illustrating a method for adding and modifying SRBs and DRBs that include numerology (sub-carrier spacing) information;

FIG. 16 is a flow diagram illustrating another method for adding and modifying SRBs and DRBs that include numerology (sub-carrier spacing) information;

FIG. 17 is a flow diagram illustrating another method for adding and modifying SRBs and DRBs that include numerology (sub-carrier spacing) information; and

FIG. 18 is a flow diagram illustrating yet another method for adding and modifying SRBs and DRBs that include numerology (sub-carrier spacing) information.

### DETAILED DESCRIPTION

A user equipment (UE) is described. The UE includes a processor and memory in electronic communication with the processor. Instructions stored in the memory are executable to receive system information comprising information elements (IEs) of a list and/or instances for allowed/supported numerologies (sub-carrier spacing) in a cell for uplink (UL) frequencies and downlink (DL) frequencies. The IEs are received over dedicated RRC signaling and/or broadcast signaling. The instructions are also executable to configure or reconfigure the UE to send and receive packets using the allowed/supported numerologies (sub-carrier spacing).

The IEs of the list and/or instances for allowed/supported numerologies (sub-carrier spacing) may include one or more supported/allowed instances numerologies (sub-carrier spacing) IE or numerology instances comprising 15 kilohertz (kHz), 30 kHz, 60 kHz, 120 kHz, or 240 kHz. The IEs of the list and/or instances for allowed/supported numerologies (sub-carrier spacing) may also include a number of numerology (carrier spacing) supported/allowed IE, or a numerology (sub-carrier spacing) list including an integer number (1-N). N may be a maximum number of numerologies allowed/supported as configured by a base station (gNB).

The instructions stored in the memory may be executable to receive an RRC message comprising information elements (IEs) including a list and/or instances of the allowed/supported numerologies (sub-carrier spacing) for the configuration of one or more of the following: a signaling radio bearer (SRB), a data radio bearer (DRB), or measurement configurations and a measurements report for inter/intra-frequency measurements comprising the allowed/supported list and/or instances of numerologies (sub-carrier spacing). The instructions may be further executable to configure or reconfigure the UE to send and receive packets using the indicated list and/or instances of the allowed/supported numerologies (sub-carrier spacing).

The UE may perform measurements using the list and/or instances of supported/allowed numerology and reports these measurements as configured.

The RRC message may include one or more of the following: an RRCConnectionSteup message, an RRCConnectionReconfiguration message, an RRCConnectionResume message, or an RRCConnectionRe-Establishment message.

The information elements (IEs) of the list and/or instances for allowed/supported numerologies (sub-carrier spacing) may be included in one or more of the following radio resource control/configuration IEs: a logical channel configuration IE, a measurement configuration IE, downlink and uplink frequency information IEs, operational system bandwidth IEs, or configured uplink grants IEs.

The allowed/supported numerology used for UL frequencies may be configured for physical uplink control channel (PUCCH) and/or physical uplink shared channel (PUSCH). The allowed/supported numerology may be used for DL frequencies is configured for physical downlink control channel (PDCCH) and/or physical downlink shared channel (PDSCH).

A base station (gNB) is also described. The gNB includes a processor and memory in electronic communication with the processor. Instructions stored in the memory are executable to send system information comprising information elements (IEs) of a list and/or instances for allowed/supported numerologies (sub-carrier spacing) in a cell for uplink (UL) frequencies and downlink (DL) frequencies. The IEs are sent over dedicated RRC signaling and/or broadcast signaling.

Another user equipment (UE) is described. The UE includes a processor and memory in electronic communication with the processor. Instructions stored in the memory are executable to send a Radio Resource Control (RRC) message to a Base Station (gNB). The RRC message includes a number of numerologies associated with supported short transmission time interval (sTTI and numerology (sub-carrier spacing)) configurations supported for one or more data radio bearers (DRBs) and/or one or more signaling radio bearers (SRBs). The RRC message also includes a list of channel spacing for the supported sTTI and numerology (sub-carrier spacing) configuration as shown below in Listing 1. An example of a SubcarrierSpacing information element (IE) is shown in Listing 1. The SubcarrierSpacing IE may determine the sub-carrier spacing.

Listing 1

| -- ASN1START | |
|---|---|
| -- TAG-SUBCARRIER-SPACING-START | |
| -- The sub-carrier spacing supported in NR. Restrictions | |
| applicable for certain frequencies, channels or signals are | |
| clarified | |
| -- in the fields that use this IE. | |
| SubcarrierSpacing ::= | ENUMERATED {kHz15, kHz30, |

kHz60, kHz120, kHz240, spare3, spare2, spare1}
-- TAG-SUBCARRIER-SPACING-STOP
-- ASN1STOP

Information regarding the numerology (sub-carrier spacing) may be included in a Logical Channel Configuration (i.e., logicalChannelConfig) information element (IE). The information regarding the numerology (sub-carrier spacing) may include one or more procedures for adding, modifying and/or reconfiguring the DRBs or SRBs.

A base station (gNB) is also described. The gNB includes a processor and memory in electronic communication with the processor. Instructions stored in the memory are executable to receive a Radio Resource Control (RRC) message from a user equipment (UE). The RRC message includes a number of numerologies associated with supported short transmission time intervals (sTTI and numerology (sub-carrier spacing)) configurations supported for one or more data radio bearers (DRBs) and/or one or more signaling radio bearers (SRBs). The RRC message also includes a list of channel spacing for the supported sTTI and numerology (sub-carrier spacing) configuration.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a gNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency/numerology (sub-carrier spacing) of the downlink resources and the carrier frequency/numerology (sub-carrier spacing) of the uplink resources may be indicated in the system information (e.g., Master Information Block (MIB) or System Information Block (SIB)) transmitted on the downlink resources.

“Configured cells” are those cells of which the UE is aware and is allowed by an eNB to transmit or receive information. “Configured cell(s)” may be serving cell(s). The UE may receive system information and/or allocation Grants to perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH) using a particular numerology (sub-carrier spacing). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics such as supported numerology (sub-carrier spacing).

Fifth generation (5G) cellular communications (also referred to as “New Radio”, “New Radio Access Technology” or “NR” by 3GPP) envisions the use of time/frequency/space resources to allow for enhanced mobile broadband (eMBB) communication and ultra-reliable low-latency communication (URLLC) services, as well as massive machine type communication (mMTC) like services. In order for the services to use the time/frequency/space medium efficiently it would be useful to be able to flexibly schedule services on the medium so that the medium may be used as effectively as possible, given the conflicting needs of URLLC, eMBB, and mMTC. An NR base station may be referred to as a gNB. A gNB may also be more generally referred to as a base station device.

The systems and methods described herein provide a modified mechanism to add, modify and/or reconfigure data radio bearers (DRBs) or signaling radio bearers (SRBs) to include information regarding the newly adopted different transmission time intervals (sTTIs) and various numerology or sub-carrier spacing. The numerology (sub-carrier spacing) information may be added to a logicalChannelConfig information element (IE) that carries all the information regarding the DRBs and SRBs. It is also added to various system information element necessary for the operation of the system (e.g., System Operational Information, Operational UL Frequency information, Operational DL Frequency information, Operational Bandwidth information, Measurements information, . . . etc.)

The numerology (sub-carrier spacing) information may include two fields. One field may be the number of instances or types of numerology (Sub-carrier spacing) supported. The other field may be the details of the channel spacing characterizing the sTTI. A UE may be able to support one or more sTTIs simultaneously as shown below in Listing 2. An example of a FrequencyInfoDL IE is shown in Listing 2. The FrequencyInfoDL IE may provide basic parameters of a downlink carrier and transmission thereon.

Listing 2

| -- ASN1START | |
|---|---|
| -- TAG-FREQUENCY-INFO-DL-START | |
| FrequencyInfoDL ::= | SEQUENCE { |
| -- Frequency of the SSB to be used for this serving cell. | |
| The frequency provided in this field identifies the position | |
| of | |
| -- resource element RE =#0 (sub-carrier #0) of resource block | |
| RB#10 of the SS block. The cell-defining SSB of an SpCell is | |
| always on | |
| -- the sync raster. Frequencies are considered to be on the | |
| sync raster if they are also identifiable with a GSCN value | |
| (see 38.101). | |
| absoluteFrequencySSB | ARFCN-ValueNR, |
| -- The frequency domain offset between SSB and the | |
| overall resource block grid in number of sub-carriers. | |
| -- Absence of the field indicates that no offset is | |
| applied (offset = 0). For FR2 only values up to 11 are | |
| applicable. | |
| -- Corresponds to L1 parameter kssb (See 38.211, section | |
| 7.4.3.1) | |
| ssb-SubcarrierOffset | INTEGER (1..23) |
| OPTIONAL, -- Need S | |
| -- List of one or multiple frequency bands to which this | |
| carrier(s) belongs. Multiple values are only supported in | |
| -- system information but not when the FrequencyInfoDL is | |
| provided in dedicated signalling (HO or S(p)Cell | |
| addition). | |
| frequencyBandList | MultiFrequencyBandListNR, |
| -- Absolute frequency position of the reference resource | |
| block (Common RB 0). Its lowest sub-carrier is also known | |
| as Point A. | |
| -- Note that the lower edge of the actual carrier is not | |
| defined by this field but rather in the scs- | |
| SpecificCarrierList. | |
| -- Corresponds to L1 parameter ‘offset-ref-low-scs-ref- | |
| PRB’ | |
| absoluteFrequencyPointA | ARFCN-ValueNR, |
| -- A set of carriers for different sub-carrier spacings | |
| (numerologies). Defined in relation to Point A. | |
| -- Corresponds to L1 parameter ‘offset-pointA-set’ | |
| scs-SpecificCarrierList | SEQUENCE (SIZE |

```
  (1..maxSCSs)) OF SCS-SpecificCarrier,
  ...
}
-- TAG-FREQUENCY-INFO-UL-STOP
-- ASN1STOP
```

An example of a FrequencyInfoUL IE is shown in Listing 3. The IE FrequencyInfoUL may provide basic parameters of an uplink carrier and transmission thereon.

Listing 3

-- ASN1START
-- TAG-FREQUENCY-INFO-UL-START

| | |
|---|---|
| FrequencyInfoUL ::= | SEQUENCE { |

```
  -- List of one or multiple frequency bands to which this
carrier(s) belongs. Multiple values are only supported in
  -- system information but not when the FrequencyInfoDL is
provided in dedicated signalling (HO or S(p)Cell addition).
```

| | |
|---|---|
| frequencyBandList | MultiFrequencyBandListNR |

```
  OPTIONAL, -- Cond FDD-OrSUL
  -- Absolute frequency of the reference resource block
  (Common RB 0). Its lowest sub-carrier is also known as Point
  A.
  -- Corresponds to L1 parameter ‘offset-ref-low-scs-ref-PRB’
```

| | |
|---|---|
| absoluteFrequencyPointA | ARFCN-ValueNR |

```
  OPTIONAL, -- Cond FDD-OrSUL
  -- A set of virtual carriers for different sub-carrier
  spacings (numerologies). Defined in relation to Point A.
  -- Note that the lower edge of the actual carrier is not
  defined by this field but rather in the scs-
  SpecificCarrierList.
  -- Corresponds to L1 parameter ‘offset-pointA-set’
```

| | |
|---|---|
| scs-SpecificCarriers | SEQUENCE (SIZE (1..maxSCSs)) |

```
  OF SCS-SpecificCarrier,
  -- The additional spectrum emission requirements to be
  applied by the UE on this uplink.
  -- If the field is absent, the UE applies the value
  FFS_RAN4. additionalSpectrumEmission
```

| | |
|---|---|
| AdditionalSpectrumEmission | OPTIONAL, -- Need S |

```
  -- FFS_Definition. Corresponds to parameter FFS_RAN4. (see
  FFS_Spec, section FFS_Section)
  -- If the field is absent, the UE applies the value
  FFS_RAN4.
```

| | |
|---|---|
| p-Max | P-Max |

```
  OPTIONAL, -- Need S
  -- Enable the NR UL transmission with a 7.5KHz shift to the
  LTE raster. If the field is absent, the frequency shift is
  disabled.
```

| | |
|---|---|
| frequencyShift7p5khz | ENUMERATED {true} |

...
}
-- TAG-FREQUENCY-INFO-UL-STOP
-- ASN1STOP

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

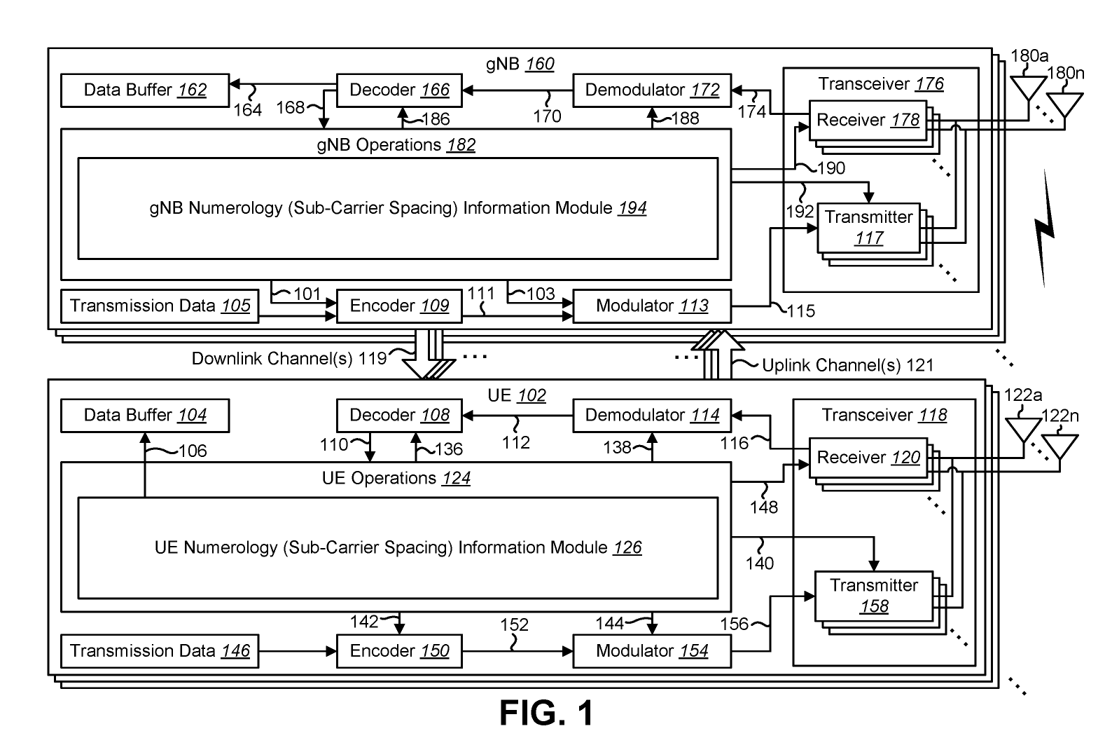

FIG. 1 is a block diagram illustrating one implementation of one or more gNBs 160 and one or more UEs 102 in which systems and methods for adding and modifying signaling radio bearers (SRBs) and data radio bearers (DRBs) that include numerology (sub-carrier spacing) information may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (Physical Uplink Shared Channel)), and/or a physical control channel (e.g., PUCCH (Physical Uplink Control Channel)), etc. The one or more gNBs 160 may also transmit information or data to the one or more UEs 102 using one or more downlink channels 119, for instance. Examples of downlink channels 119 physical shared channel (e.g., PDSCH (Physical Downlink Shared Channel), and/or a physical control channel (PDCCH (Physical Downlink Control Channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE numerology (sub-carrier spacing) information module 126.

The systems and methods described herein provide a modified mechanism to add, modify and/or reconfigure, Data Radio Bearers (DRBs) or Signaling Radio Bearer (SRBs) to include information regarding the newly adopted short TTIs (sTTIs) formats and newly added numerology (sub-carrier spacing). Numerology (sub-carrier spacing) information may be added to the logicalChannelConfig IE that carries the information regarding the DRBs and SRBs. The numerology (sub-carrier spacing) information may include two fields. One field may be the number of instances or types of sTTI and numerology (sub-carrier spacing) supported and the other field may be the details of the channel spacing characterizing the sTTI and numerology (sub-carrier spacing). The UE 102 may be able to support one or more sTTI and numerology (sub-carrier spacing) simultaneously.

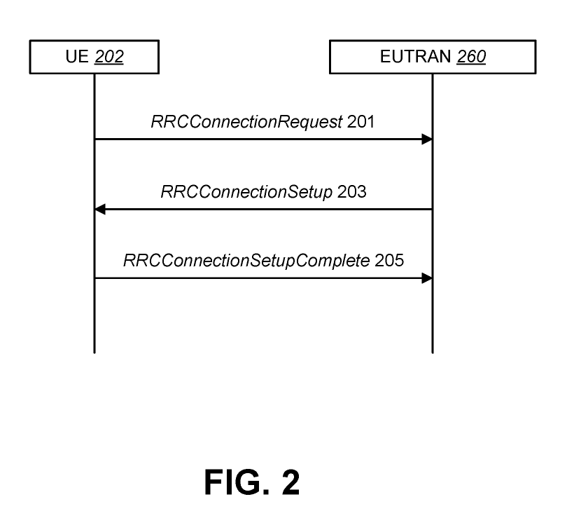

Modifications to the process in 3GPP TS 36.331 are described herein. Radio Resource Control (RRC) connection establishment is described in connection with FIGS. 2-6. The purpose of this RRC connection establishment procedure is to establish or resume an RRC connection. RRC connection establishment involves SRB1 (and SRB1bis for NB-IoT) establishment. The procedure is also used to transfer the initial NAS dedicated information/message from the UE 102 to E-UTRAN.

E-UTRAN may apply the RRC connection establishment procedure. In one case, when establishing an RRC connection, the E-UTRAN may establish SRB1 and, for NB-IoT, SRB1bis. When resuming an RRC connection, the E-UTRAN may restore the AS configuration from a stored context including resuming SRB(s) and DRB(s).

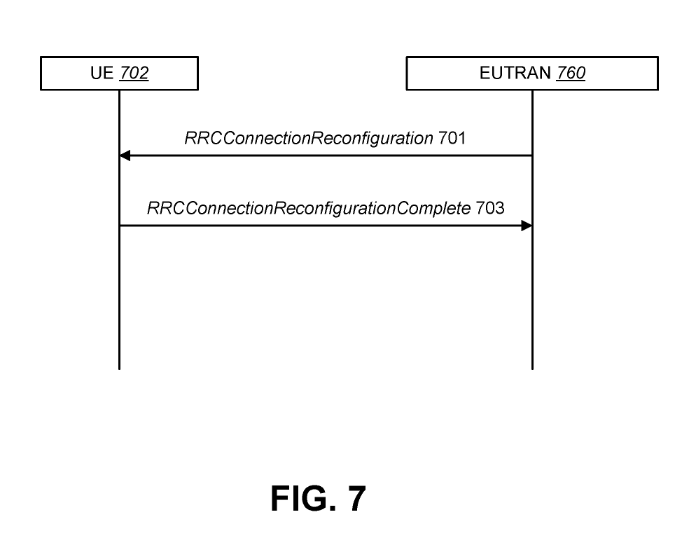

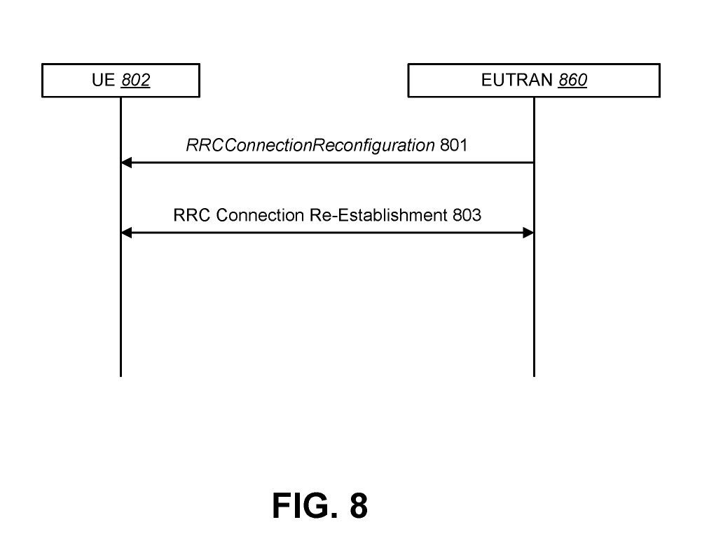

RRC connection reconfiguration is also described in connection with FIGS. 7-8. The purpose of this procedure is to modify an RRC connection (e.g., to establish, modify, and/or release RBs; to perform handover; to setup, modify and/or release measurements; and to add, modify and/or release SCells). As part of the RRC connection reconfiguration procedure, NAS dedicated information may be transferred from E-UTRAN to the UE 102 as shown in Listing 4 below. An example of a MeasObjectNR IE is shown in Listing 4. The IE MeasObjectNR may specify information applicable for SS/PBCH block(s) intra/inter-frequency measurements or CSI-RS intra/inter-frequency measurements.

Listing 4

-- ASN1START
-- TAG-MEAS-OBJECT-NR-START

| | |
|---|---|
| MeasObjectNR ::= | SEQUENCE { |
| ssbFrequency | ARFCN-ValueNR |
| refFreqCSI-RS | ARFCN-ValueNR |
| OPTIONAL, | |

--RS configuration (e.g. SMTC window, CSI-RS resource, etc.)

| | |
|---|---|
| referenceSignalConfig | ReferenceSignalConfig, |

--Consolidation of L1 measurements per RS index

| | |
|---|---|
| absThreshSS-BlocksConsolidation | ThresholdNR |
| absThreshCSI-RS-Consolidation | ThresholdNR |

--Config for cell measurement derivation

| | |
|---|---|
| nrofSS-BlocksToAverage | INTEGER (2..maxNrofSS- |
| BlocksToAverage) | OPTIONAL, -- Need |
| R | |
| nrofCSI-RS-ResourcesToAverage | INTEGER (2..maxNrofCSI- |
| RS-ResourcesToAverage) | OPTIONAL, -- Need |
| R | |

-- Filter coefficients applicable to this measurement object

| | |
|---|---|
| quantityConfigIndex | INTEGER |
| (1..maxNrofQuantityConfig), | |
| --Frequency-specific offsets | |
| offsetFreq | Q-OffsetRangeList, |
| -- Cell list | |
| cellsToRemoveList | PCI-List |
| OPTIONAL, -- Need N | |
| cellsToAddModList | CellsToAddModList |
| OPTIONAL, -- Need N | |
| -- Black list | |
| blackCellsToRemoveList | PCI-RangeIndexList |
| blackCellsToAddModList | BlackCellsToAddModList |
| -- White list | |
| whiteCellsToRemoveList | PCI-RangeIndexList |
| whiteCellsToAddModList | WhiteCellsToAddModList |
| ... | |
| } | |
| ReferenceSignalConfig::= | SEQUENCE { |

-- SSB configuration for mobility (nominal SSBs, timing

| | |
|---|---|
| configuration) | |
| ssb-ConfigMobility | SSB-ConfigMobility |

-- CSI-RS resources to be used for CSI-RS based RRM

| | |
|---|---|
| measurements | |
| csi-rs-ResourceConfigMobility | SetupRelease { CSI-RS- |

ResourceConfigMobility } OPTIONAL-- Need M

}

-- A measurement timing configuration
SSB-ConfigMobility::= SEQUENCE {
--Only the values 15, 30 or 60 kHz (<6GHz), 60 or 120
kHz (>6GHz) are applicable

| | |
|---|---|
| sub-carrierSpacing | SubcarrierSpacing, |

```
    -- The set of SS blocks to be measured within the SMTC
measurement duration.
    -- Corresponds to L1 parameter ‘SSB-measured’ (see
FFS_Spec, section FFS_Section)
    -- When the field is absent the UE measures on all SS-
blocks
    -- FFS_CHECK: Is this IE placed correctly.
```

| | |
|---|---|
| ssb-ToMeasure | SetupRelease { SSB- |
| ToMeasure } | OPTIONAL, -- Need M |

-- Indicates whether the UE can utilize serving cell timing
to derive the index of SS block transmitted by neighbour cell:

| | |
|---|---|
| useServingCellTimingForSync | BOOLEAN, |

-- Primary measurement timing configuration. Applicable for
intra- and inter-frequency measurements.

| | |
|---|---|
| smtc1 | SEQUENCE { |

```
    -- Periodicity and offset of the measurement window in
which to receive SS/PBCH blocks.
    -- Periodicity and offset are given in number of
subframes.
    -- FFS_FIXME: This does not match the L1 parameter table!
They seem to intend an index to a hidden table in L1 specs.
    -- (see 38.213, section REF):
```

| | |
|---|---|
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

```
    },
    -- Duration of the measurement window in which to receive
SS/PBCH blocks. It is given in number of subframes
    -- (see 38.213, section 4.1)
```

| | |
|---|---|
| duration | ENUMERATED { sf1, sf2, sf3, |

```
sf4, sf5 }
  },
  -- Secondary measurement timing confguration for explicitly
signalled PCIs. It uses the offset and duration from smtc1.
  -- It is supported only for intra-frequency measurements in
RRC CONNECTED.
```

| | |
|---|---|
| smtc2 | SEQUENCE { |

-- PCIs that are known to follow this SMTC.

| | |
|---|---|
| pci-List | SEQUENCE (SIZE |
| (1..maxNrofPCIsPerSMTC)) OF PhysCellId | OPTIONAL, -- Need |

M
-- Periodicity for the given PCIs. Timing offset and
Duration as provided in smtc1.

| | |
|---|---|
| periodicity | ENUMERATED fsf5, sf10, |

```
sf20, sf40, sf80, sf160, spare2, spare1}
  }
  OPTIONAL,-- Cond IntraFreqConnected
```

| | |
|---|---|
| ss-RSSI-Measurement | SEQUENCE { |
| measurementSlots | CHOICE { |
| kHz15 | BIT STRING (SIZE(1)), |
| kHz30 | BIT STRING (SIZE(2)), |
| kHz60 | BIT STRING (SIZE(4)), |
| kHz120 | BIT STRING |

(SIZE (8))
},

| | |
|---|---|
| endSymbol | INTEGER(0..13) |

```
  }
  OPTIONAL
}
```

| | |
|---|---|
| CSI-RS-ResourceConfigMobility ::= | SEQUENCE { |

-- MO specific values

| | |
|---|---|
| isServingCellMO | BOOLEAN, |

```
  -- Subcarrier spacing of CSI-RS.
  -- Only the values 15, 30 or 60 kHz (<6GHz), 60 or 120 kHz
(>6GHz) are applicable.
  -- Corresponds to L1 parameter ‘Numerology’ (see 38.211,
section FFS_Section)
```

| | |
|---|---|
| sub-carrierSpacing | SubcarrierSpacing, |

```
  -- List of cells
  csi-RS-CellList-Mobility SEQUENCE (SIZE (1..maxNrofCSI-RS-
CellsRRM)) OF CSI-RS-CellMobility
}
```

| | |
|---|---|
| CSI-RS-CellMobility ::= | SEQUENCE { |
| cellId | PhysCellId, |
| csi-rs-MeasurementBW | SEQUENCE { |

```
    -- Allowed size of the measurement BW in PRBs
    -- Corresponds to L1 parameter ‘CSI-RS-measurementBW-
size’ (see FFS_Spec, section FFS_Section)
```

| | |
|---|---|
| nrofPRBs | ENUMERATED { size24, size48, size96, |

```
size192, size264},
    -- Starting PRB index of the measurement bandwidth
    -- Corresponds to L1 parameter ‘CSI-RS-measurement-BW-
start’ (see FFS_Spec, section FFS_Section)
    -- FFS_Value: Upper edge of value range unclear in RAN1
```

| | |
|---|---|
| startPRB | INTEGER(0..2169) |

```
  },
  -- Frequency domain density for the 1-port CSI-RS for L3
mobility
  -- Corresponds to L1 parameter ‘Density’ (see FFS_Spec,
section FFS_Section)
```

| | |
|---|---|
| density | ENUMERATED {d1,d3} |

-- List of resources
csi-rs-ResourceList-Mobility SEQUENCE (SIZE (1..maxNrofCSI-
RS-ResourcesRRM)) OF CSI-RS-Resource-Mobility
}

| | |
|---|---|
| CSI-RS-Resource-Mobility ::= | SEQUENCE { |
| csi-RS-Index | CSI-RS-Index, |

-- Contains periodicity and slot offset for periodic/semi-
persistent CSI-RS (see 38.211, section x.x.x.x)FFS_Ref

| | |
|---|---|
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

```
  },
  -- Each CSI-RS resource may be associated with one SSB. If
such SSB is indicated, the NW also indicates whether the UE
may assume
  -- quasi-colocation of this SSB with this CSI-RS reosurce.
  -- Corresponds to L1 parameter ‘Associated-SSB’ (see
FFS_Spec, section FFS_Section)
```

| | |
|---|---|
| associatedSSB | SEQUENCE { |
| ssb-Index | SSB-Index, |

```
    -- The CSI-RS resource is either QCL'ed not QCL'ed with
the associated SSB in spatial parameters
    -- Corresponds to L1 parameter ‘QCLed-SSB’ (see FFS_Spec,
section FFS_Section)
```

| | |
|---|---|
| isQuasiColocated | BOOLEAN |

| | |
|---|---|
| } | OPTIONAL, -- Cond AssociatedSSB |

```
  -- Frequency domain allocation within a physical resource
block in accordance with 38.211, section 7.4.1.5.3 including
table 7.4.1.5.2-1.
  -- The number of bits that may be set to one depend on the
chosen row in that table. For the choice “other”, the row can
be determined from
  -- the parmeters below and from the number of bits set to 1
in frequencyDomainAllocation.
```

| | |
|---|---|
| frequencyDomainAllocation | CHOICE { |
| row1 | BIT STRING (SIZE (4)), |
| row2 | BIT STRING (SIZE (12)) |
| }, | |

```
  -- Time domain allocation within a physical resource block.
The field indicates the first OFDM symbol in the PRB used for
CSI-RS.
  -- Parameter 10 in 38.211, section 7.4.1.5.3. Value 2 is
supported only when DL-DMRS-typeA-pos equals 3.
```

| | |
|---|---|
| firstOFDMSymbolInTimeDomain | INTEGER (0..13), |

-- Scrambling ID for CSI-RS(see 38.211, section 7.4.1.5.2)

| | |
|---|---|
| sequenceGenerationConfig | INTEGER (0..1023), |
| ... | |
| } | |

| | |
|---|---|
| CSI-RS-Index ::= | INTEGER (0..maxNrofCSI-RS- |

| ResourcesRRM-1) | | |
|---|---|---|
| Q-OffsetRangeList ::= | SEQUENCE { | |
| rsrpOffsetSSB | Q-OffsetRange | DEFAULT |
| dB 0, | | |
| rsrgOffsetSSB | Q-OffsetRange | DEFAULT |
| dB 0, | | |
| sinrOffsetSSB | Q-OffsetRange | DEFAULT |
| dB 0, | | |
| rsrpOffsetCSI-RS | Q-OffsetRange | DEFAULT |
| dB 0, | | |
| rsrgOffsetCSI-RS | Q-OffsetRange | DEFAULT |
| dB 0, | | |
| sinrOffsetCSI-RS | Q-OffsetRange | DEFAULT |
| dB0 | | |
| } | | |

| | |
|---|---|
| SSB-ToMeasure ::= | CHOICE { |

| | |
|---|---|
| -- bitmap for sub 3 GHz | |
| shortBitmap | BIT STRING (SIZE (4)), |
| -- bitmap for 3-6 GHz | |
| mediumBitmap | BIT STRING (SIZE (8)), |
| -- bitmap for above 6 GHz | |
| longBitmap | BIT STRING (SIZE (64)) |
| } | |
| ThresholdNR ::= | SEQUENCE{ |
| thresholdRSRP | RSRP-Range |
| OPTIONAL, | |
| thresholdRSRQ | RSRQ-Range |
| OPTIONAL, | |
| thresholdSINR | SINR-Range |
| OPTIONAL | |
| } | |
| CellsToAddModList ::= | SEQUENCE (SIZE |

(1..maxNrofCellMeas)) OF CellsToAddMod

| | |
|---|---|
| CellsToAddMod ::= | SEQUENCE { |
| physCellId | PhysCellId, |
| cellIndividualOffset | Q-OffsetRangeList |
| } | |
| BlackCellsToAddModList ::= | SEQUENCE (SIZE |

(1..maxNrofPCI-Ranges)) OF BlackCellsToAddMod

| | |
|---|---|
| BlackCellsToAddMod ::= | SEQUENCE { |
| pci-RangeIndex | PCI-RangeIndex, |
| pci-Range | PCI-Range |
| } | |
| WhiteCellsToAddModList ::= | SEQUENCE (SIZE |

(1..maxNrofPCI-Ranges)) OF WhiteCellsToAddMod

| | |
|---|---|
| WhiteCellsToAddMod ::= | SEQUENCE { |
| pci-RangeIndex | PCI-RangeIndex, |
| pci-Range | PCI-Range |
| } | |
| -- TAG-MEAS-OBJECT-NR-STOP | |
| -- ASN1STOP | |

In Listing 4, absThreshCSI-RS-Consolidation may be an absolute threshold for the consolidation of measurement results per CSI-RS resource(s) from L1 filter(s). The values above the threshold are used as input to the derivation of cell measurement results as described in 5.5.3.3 and the L3 filter(s) per CSI-RS resource as described in 5.5.3.2.

The absThreshSS-BlocksConsolidation field may be an absolute threshold for the consolidation of measurement results per SS/PBCH block(s) from L1 filter(s). The values above the threshold are used as input to the derivation of cell measurement results as described in 5.5.3.3 and the L3 filter(s) per SS/PBCH block index as described in 5.5.3.2.

If the associatedSSB is present, the UE may base the timing of the CSI-RS resource indicated in CSI-RS-Resource-Mobility on the timing of the cell indicated by the cellId in the CSI-RS-CellMobility. In this case, the UE is not required to monitor that CSI-RS resource if the UE cannot detect the SS/PBCH block indicated by this associatedSSB and cellId. If this field is absent, the UE may base the timing of the CSI-RS resource indicated in CSI-RS-Resource-Mobility on the timing of the serving cell. In this case, the UE is required to measure the CSI-RS resource even if SS/PBCH block(s) with cellId in the CSI-RS-CellMobility are not detected.

The blackCellsToAddModList field is a list of cells to add/modify in the black list of cells.

The blackCellsToRemoveList field is a list of cells to remove from the black list of cells.

The celllndividualOffset field is a cell individual offsets applicable to a specific cell.

The cellsToAddModList field is a list of cells to add/modify in the cell list.

The cellsToRemoveList field is a list of cells to remove from the cell list.

The csi-RS-Index field is a CSI-RS resource index associated to the CSI-RS resource to be measured (and used for reporting).

The endSymbol field is the RSSI is measured from symbol 0 to symbol endSymbol.

The nrofCSInrofCSI-RS-ResourcesToAverage field indicates the maximum number of measurement results per beam based on CSI-RS resources to be averaged. The same value applies for each detected cell associated with this MeasObjectNR.

The nrofSS-BlocksToAverage field indicates the maximum number of measurement results per beam based on SS/PBCH blocks to be averaged. The same value applies for each detected cell associated with this MeasObject.

The offsetFreq field includes offset values applicable to the carrier frequency.

The physCellId field is a physical cell identity of a cell in the cell list.

The quantityConfigIndex field indicates the n-th element of quantityConfigNR-Listprovided in MeasConfig.

The pci-Range field is a physical cell identity or a range of physical cell identities.

The measurementSlots field indicates the slots in which the UE can perform RSSI measurements.

The slotConfig field indicates the CSI-RS periodicity (in milliseconds) and for each periodicity the offset (in number of slots). When sub-carrierSpacingCSI-RS is set to 15 kHZ, the maximum offset values for periodicities ms4/ms5/ms10/ms20/ms40 are 3/4/9/19/39 slots. When sub-carrierSpacingCSI-RS is set to 30 kHZ, the maximum offset values for periodicities ms4/ms5/ms10/ms20/ms40 are 7/9/19/39/79 slots. When sub-carrierSpacingCSI-RS is set to 60 kHZ, the maximum offset values for periodicities ms4/ms5/ms10/ms20/ms40 are 15/19/39/79/159 slots. When sub-carrierSpacingCSI-RS is set 120 kHZ, the maximum offset values for periodicities ms4/ms5/ms10/ms20/ms40 are 31/39/79/159/319 slots.

The ssbFrequency field indicates the frequency of the SS associated to this MeasObjectNR. For cell defining SSB, it will be located on the sync raster.

The white CellsToAddModList field is a list of cells to add/modify in the white list of cells.

The whiteCellsToRemoveList field is a list of cells to remove from the white list of cells.

SRB addition and/or modification is also described herein. If the UE 102 is a NB-IoT UE and SRB1 is not established or for each srb-Identity value included in the srb-ToAddModList that is not part of the current UE configuration (SRB establishment), the UE 102 may perform one or more of the following operations. If the UE 102 is not a NB-IoT UE that only supports the Control Plane CIoT EPS optimization, then the UE 102 may apply the specified configuration defined in TS 36.331 9.1.2 for the corresponding SRB. The UE 102 may also establish a Packet Data Convergence Protocol (PDCP) entity and configure it with the current master cell group (MCG) security configuration, if applicable. The UE 102 may also establish an (MCG) RLC entity in accordance with the received rlc-Config. The UE 102 may further establish a (MCG) Dedicated Control Channel (DCCH) logical channel in accordance with the received logicalChannelConfig and with the logical channel identity set in accordance with 9.1.2.

If the UE 102 is a NB-IoT UE, then the UE 102 may apply the specified configuration defined in 9.1.2 for SRB1bis. The UE 102 may also establish an (MCG) RLC entity in accordance with the received rlc-Config. The UE 102 may further establish a (MCG) DCCH logical channel in accordance with the received logicalChannelConfig and with the logical channel identity set in accordance with 9.1.2.1a.

If the UE 102 is a NB-IoT UE and SRB1 is established, or for each srb-Identity value included in the srb-ToAddModList that is part of the current UE configuration (SRB reconfiguration), the UE 102 may reconfigure the RLC entity in accordance with the received rlc-Config. The UE 102 may also reconfigure the DCCH logical channel in accordance with the received logicalChannelConfig as shown in Listings 5-7 below.

Listing 5 provides an example of an SRB1 and/or SRB1S configuration.

Listing 5

| | | | |
|---|---|---|---|
| | | Semantics | |
| Name | Value | description | Ver |

| | | |
|---|---|---|
| PDCP-Config | | |
| >t-Reordering | infinity | |
| RLC-Config CHOICE | am | |
| ul-RLC-Config | | |
| >sn-FieldLength | size12 | |
| >t-PollRetransmit | ms45 | |
| >pollPDU | infinity | |
| >pollByte | infinity | |
| >maxRetxThreshold | t4 | |
| dl-RLC-Config | | |
| >sn-FieldLength | size12 | |
| >t-Reassembly | ms35 | |
| >t-Status Prohibit | ms0 | |
| LogicalChannelConfig | | |
| >priority | 1 | Highest priority |
| >prioritisedBitRate | infinity | |
| >bucketSizeDuration | N/A | |
| >allowedSubCarrierSpacing | FFS | |
| >allowedTiming | FFS | |
| >logicalChannelGroup | 0 | |
| >logicalChannelSR- | false | |
| DelayTimerApplied | | |

Listing 6 provides an example of an SRB2 and/or SRB2S configuration.

Listing 6

| | | | |
|---|---|---|---|
| | | Semantics | |
| Name | Value | description | Ver |

| | |
|---|---|
| PDCP-Config | |
| >t-Reordering | infinity |
| RLC-Config CHOICE | am |
| ul-RLC-Config | |
| >sn-FieldLength | size12 |
| > t-PollRetransmit | ms45 |
| >pollPDU | infinity |
| >pollByte | infinity |
| >maxRetxThreshold | t4 |
| dl-RLC-Config | |
| >sn-FieldLength | size12 |
| >t-Reassembly | ms35 |
| >t-Status Prohibit | ms0 |
| LogicalChannelConfig | |
| >priority | 3 |
| >prioritisedBitRate | infinity |
| >bucketSizeDuration | N/A |
| >allowedSubCarrierSpacing | FFS |
| >allowedTiming | FFS |
| >logicalChannelGroup | 0 |
| >logicalChannelSR- | false |
| DelayTimerApplied | |

Listing 7 provides an example of an SRB3 configuration.

Listing 7

| | | | |
|---|---|---|---|
| | | Semantics | |
| Name | Value | description | Ver |

| | | |
|---|---|---|
| PDCP-Config | | |
| >t-Reordering | infinity | |
| RLC-Config CHOICE | am | |
| ul-RLC-Config | | |
| >sn-FieldLength | size12 | |
| >t-PollRetransmit | ms45 | |
| >pollPDU | infinity | |
| >pollByte | infinity | |
| >maxRetxThreshold | t4 | |
| dl-RLC-Config | | |
| >sn-FieldLength | size12 | |
| >t-Reassembly | ms35 | |
| >t-Status Prohibit | ms0 | |
| LogicalChannelConfig | | |
| >priority | 1 | Highest priority |
| >prioritisedBitRate | infinity | |
| >bucketSizeDuration | N/A | |
| >allowedSubCarrierSpacing | FFS | |
| >allowedTiming | FFS | |
| >logicalChannelGroup | 0 | |
| >logicalChannelSR- | false | |
| DelayTimerApplied | | |

DRB addition and/or modification is also described herein. For each drb-Identity value included in the drb-ToAddModList that is not part of the current UE configuration (DRB establishment including the case when full configuration option is used), if the concerned entry of drb-ToAddModList includes the drb-TypeLWA set to TRUE (i.e., add LTE-WLAN aggregation (LWA) DRB), then the UE 102 may perform the LWA specific DRB addition or reconfiguration as specified in 5.3.10.3a2.

If the concerned entry of drb-ToAddModList includes the drb-TypeLWIP (i.e., add LWIP DRB), then the UE 102 may perform LWIP specific DRB addition or reconfiguration as specified in 5.3.10.3a3. Otherwise, if drb-ToAddModListSCG is not received or does not include the drb-Identity value (i.e., add MCG DRB), then the UE 102 may establish a PDCP entity and configure it with the current MCG security configuration and in accordance with the received pdcp-Config. The UE 102 may also establish an MCG RLC entity or entities in accordance with the received rlc-Config. The UE 102 may further establish an MCG DTCH logical channel in accordance with the received logicalChannelIdentity and the received logicalChannelConfig.

If the RRCConnectionReconfiguration message includes the fullConfig IE, then the UE 102 may associate the established DRB with corresponding included eps-BearerIdentity. Otherwise, the UE 102 may indicate the establishment of the DRB(s) and the eps-BearerIdentity of the established DRB(s) to upper layers.

For each drb-Identity value included in the drb-ToAddModList that is part of the current UE configuration (DRB reconfiguration), if the DRB indicated by drb-Identity is an LWA DRB (i.e., LWA to LTE only or reconfigure LWA DRB), then the UE 102 may perform the LWA specific DRB reconfiguration, as specified in 5.3.10.3a2. Otherwise, if the concerned entry of drb-ToAddModList includes the drb-TypeLWA set to TRUE (i.e., LTE only to LWA DRB), then the UE 102 may perform the LWA specific DRB reconfiguration as specified in 5.3.10.3a2.

If the concerned entry of drb-ToAddModList includes the drb-TypeLWIP (i.e., add or reconfigure LWIP DRB), then the UE 102 may perform LWIP specific DRB addition or reconfiguration as specified in 5.3.10.3a3.

If drb-ToAddModListSCG is not received or does not include the drb-Identity value, then if the DRB indicated by drb-Identity is an MCG DRB (reconfigure MCG), and if the pdcp-Config is included, then the UE 102 may reconfigure the PDCP entity in accordance with the received pdcp-Config. If the rlc-Config is included, then the UE 102 may reconfigure the RLC entity or entities in accordance with the received rlc-Config. If the logicalChannelConfig is included, then the UE 102 may reconfigure the DTCH logical channel in accordance with the received logicalChannelConfig.

It should be noted that removal and addition of the same drb-Identity in a single radioResourceConfigDedicated is not supported. In case drb-Identity is removed and added due to handover or re-establishment with the full configuration option, the eNB/gNB 160 can use the same value of drb-Identity.

DC-specific DRB addition or reconfiguration is also described herein. For the drb-Identity value for which this procedure is initiated, if drb-ToAddModListSCG is received and includes the drb-Identity value, and if drb-Identity value is not part of the current UE configuration (i.e., DC specific DRB establishment), and if drb-ToAddModList is received and includes the drb-Identity value (i.e., add split DRB), then the UE 102 may establish a PDCP entity and configure it with the current MCG security configuration and in accordance with the pdcp-Config included in drb-ToAddModList. The UE 102 may also establish an MCG RLC entity and an MCG DTCH logical channel in accordance with the rlc-Config, logicalChannelIdentity and logicalChannelConfig included in drb-ToAddModList. The UE 102 may further establish a secondary cell group (SCG) RLC entity and an SCG DTCH logical channel in accordance with the rlc-ConfigSCG, logicalChannelIdentitySCG and logicalChannelConfigSCG included in drb-ToAddModListSCG.

Otherwise (i.e., add SCG DRB), the UE 102 may establish a PDCP entity and configure it with the current SCG security configuration and in accordance with the pdcp-Config included in drb-ToAddModListSCG. The UE 102 may also establish an SCG RLC entity or entities and an SCG DTCH logical channel in accordance with the rlc-ConfigSCG, logicalChannelIdentitySCG and logicalChannelConfigSCG included in drb-ToAddModListSCG.

In the case when the drb-Identity value for which this procedure is initiated, if drb-ToAddModListSCG is received and includes the drb-Identity value, and if drb-Identity value is not part of the current UE configuration (i.e., DC specific DRB establishment), the UE 102 may also indicate the establishment of the DRB(s) and the eps-BearerIdentity of the established DRB(s) to upper layers.

Otherwise (i.e., DC specific DRB modification; drb-ToAddModList and/or drb-ToAddModListSCG received), if the DRB indicated by drb-Identity is a split DRB, and if drb-ToAddModList is received and includes the drb-Identity value, while for this entry drb-TypeChange is included and set to MCG (i.e., split to MCG), then the UE 102 may release the SCG RLC entity and the SCG Dedicated Traffic Channel (DTCH) logical channel. The UE 102 may also reconfigure the PDCP entity in accordance with the pdcp-Config, if included in drb-ToAddModList. The UE 102 may further reconfigure the MCG RLC entity and/or the MCG DTCH logical channel in accordance with the rlc-Config and logicalChannelConfig, if included in drb-ToAddModList.

Otherwise (i.e., reconfigure split), the UE 102 may reconfigure the PDCP entity in accordance with the pdcp-Config, if included in drb-ToAddModList. The UE 102 may also reconfigure the MCG RLC entity and/or the MCG DTCH logical channel in accordance with the rlc-Config and logicalChannelConfig, if included in drb-ToAddModList. The UE 102 may further reconfigure the SCG RLC entity and/or the SCG DTCH logical channel in accordance with the rlc-ConfigSCG and logicalChannelConfigSCG, if included in drb-ToAddModListSCG.

If the DRB indicated by drb-Identity is an SCG DRB, and if drb-ToAddModList is received and includes the drb-Identity value, while for this entry drb-TypeChange is included and set to MCG (i.e., SCG to MCG), then the UE 102 may reconfigure the PDCP entity with the current MCG security configuration and in accordance with the pdcp-Config, if included in drb-ToAddModList. The UE 102 may also reconfigure the SCG RLC entity or entities and the SCG DTCH logical channel to be an MCG RLC entity or entities and an MCG DTCH logical channel. The UE 102 may further reconfigure the MCG RLC entity or entities and/or the MCG DTCH logical channel in accordance with the rlc-Config, logicalChannelIdentity and logicalChannelConfig, if included in drb-ToAddModList.

Otherwise (i.e., drb-ToAddModListSCG is received and includes the drb-Identity value (i.e., reconfigure SCG)), the UE 102 may reconfigure the PDCP entity in accordance with the pdcp-Config, if included in drb-ToAddModListSCG. The UE 102 may also reconfigure the SCG RLC entity or entities and/or the SCG DTCH logical channel in accordance with the rlc-ConfigSCG and logicalChannelConfigSCG, if included in drb-ToAddModListSCG.

If the DRB indicated by drb-Identity is an MCG DRB, and if drb-ToAddModListSCG is received and includes the drb-Identity value, while for this entry drb-Type is included and set to split (i.e., MCG to split), then the UE 102 may reconfigure the PDCP entity in accordance with the pdcp-Config, if included in drb-ToAddModList. The UE 102 may also reconfigure the MCG RLC entity and/or the MCG DTCH logical channel in accordance with the rlc-Config and logicalChannelConfig, if included in drb-ToAddModList. The UE 102 may further establish an SCG RLC entity and an SCG DTCH logical channel in accordance with the rlc-ConfigSCG, logicalChannelIdentitySCG and logicalChannelConfigSCG, included in drb-ToAddModListSCG.

Otherwise (i.e., drb-Type is included and set to scg (i.e., MCG to SCG)), the UE 102 may reconfigure the PDCP entity with the current SCG security configuration and in accordance with the pdcp-Config, if included in drb-ToAddModListSCG. The UE 102 may also reconfigure the MCG RLC entity or entities and the MCG DTCH logical channel to be an SCG RLC entity or entities and an SCG DTCH logical channel. The UE 102 may further reconfigure the SCG RLC entity or entities and/or the SCG DTCH logical channel in accordance with the rlc-ConfigSCG, logicalChannelIdentitySCG and logicalChannelConfigSCG, if included in drb-ToAddModListSCG.

LWA specific DRB addition or reconfiguration is also described herein. For the drb-Identity value for which this procedure is initiated, if the drb-Identity value is not part of the current UE configuration (i.e., add LWA DRB), then the UE 102 may establish a PDCP entity and configure it with the current security configuration and in accordance with the pdcp-Config included in drb-ToAddModList. The UE 102 may also establish an RLC entity and a DTCH logical channel in accordance with the rlc-Config, logicalChannelIdentity and logicalChannelConfig included in drb-ToAddModList. The UE 102 may further enable data handling for this DRB at the LTE-WLAN Aggregation Adaptation Protocol (LWAAP) entity. If lwa-WLAN-AC is configured, the UE 102 may apply the received lwa-WLAN-AC when performing transmissions of packets for this DRB over WLAN. The UE 102 may also indicate the establishment of the DRB and the eps-BearerIdentity of the established DRB to upper layers.

Otherwise, if the DRB indicated by drb-Identity is not an LWA DRB (i.e., LTE only to LWA DRB), then the UE 102 may reconfigure the PDCP entity in accordance with the pdcp-Config, if included in drb-ToAddModList. The UE 102 may reconfigure the RLC entity and/or the DTCH logical channel in accordance with the rlc-Config and logicalChannelConfig, if included in drb-ToAddModList. The UE 102 may enable data handling for this DRB at the LWAAP entity. If lwa-WLAN-AC is configured, the UE 102 may apply the received lwa-WLAN-AC when performing transmissions of packets for this DRB over WLAN.

Otherwise, if the concerned entry of drb-ToAddModList includes the drb-TypeLWA set to FALSE (i.e., LWA to LTE only DRB), then the UE 102 may reconfigure the PDCP entity in accordance with the pdcp-Config, if included in drb-ToAddModList. The UE 102 may also reconfigure the RLC entity and/or the DTCH logical channel in accordance with the rlc-Config and logicalChannelConfig, if included in drb-ToAddModList. The UE 102 may further perform PDCP data recovery as specified in TS 36.323 [8]. The UE 102 may also disable data handling for this DRB at the LWAAP entity.

Otherwise (i.e., reconfigure LWA DRB), the UE 102 may reconfigure the PDCP entity in accordance with the pdcp-Config, if included in drb-ToAddModList. The UE 102 may reconfigure the RLC entity and/or the DTCH logical channel in accordance with the rlc-Config and logicalChannelConfig, if included in drb-ToAddModList. If lwa-WLAN-AC is configured, then the UE 102 may apply the received lwa-WLAN-AC when performing transmissions of packets for this DRB over WLAN.

RRC information elements are described herein. The IE RadioResourceConfigDedicated may be used to setup, modify and/or release RBs; to modify the MAC main configuration; to modify the SPS configuration; and to modify dedicated physical configuration. An example of a RadioResourceConfigDedicated information element is provided in Listing 8.

Listing 8

-- ASN1START

| RadioResourceConfigDedicated ::= | | SEQUENCE { |
|---|---|---|
| srb-ToAddModList | | SRB-ToAddModList |
| OPTIONAL, | -- Cond HO-Conn | |
| drb-ToAddModList | | DRB-ToAddModList |
| OPTIONAL, | -- Cond HO-toEUTRA | |
| drb-ToReleaseList | | DRB-ToReleaseList |
| OPTIONAL, | -- Need ON | |
| mac-MainConfig | | CHOICE { |
| explicitValue | | MAC-MainConfig, |
| defaultValue | | NULL |
| } OPTIONAL, | -- Cond HO-toEUTRA2 | |
| sps-Config | | SPS-Config |
| OPTIONAL, | -- Need ON | |
| physicalConfigDedicated | | PhysicalConfigDedicated |
| OPTIONAL, | -- Need ON | |
| ..., | | |
| [[ rlf-TimersAndConstants-r9 | | RLF-TimersAndConstants-r9 |
| OPTIONAL | -- Need ON | |
| ]], | | |
| [[ measSubframePatternPCell-r10 | | MeasSubframePatternPCell-r10 |
| OPTIONAL | -- Need ON | |
| ]], | | |
| [[ neighCellsCRS-Info-r11 | | NeighCellsCRS-Info-r11 |
| OPTIONAL | -- Need ON | |
| ]], | | |
| [[ naics-Info-r12 | | NAICS-AssistanceInfo-r12 |
| OPTIONAL | -- Need ON | |
| ]], | | |
| [[ neighCellsCRS-Info-r13 | | NeighCellsCRS-Info-r13 |
| OPTIONAL, | -- Cond CRSIM | |
| rlf-TimersAndConstants-r13 | | RLF-TimersAndConstants-r13 |
| OPTIONAL | -- Need ON | |
| ]], | | |
| [[ sps-Config-v14xy | | SPS-Config-v14xy |
| OPTIONAL | -- Need ON | |

| | |
|---|---|
| ]] | |
| } | |
| RadioResourceConfigDedicatedPSCell-r12 ::= | SEQUENCE { |

-- UE specific configuration extensions applicable for an

| PSCell | | |
|---|---|---|
| physicalConfigDedicatedPSCell-r12 | | |
| PhysicalConfigDedicated | | |
| OPTIONAL, | -- Need ON | |
| sps-Config-r12 | | SPS-Config |
| OPTIONAL, | -- Need ON | |
| naics-Info-r12 | | NAICS-AssistanceInfo- |
| r12 | | |
| OPTIONAL, | -- Need ON | |
| ..., | | |
| [[ neighCellsCRS-InfoPSCell-r13 | | NeighCellsCRS-Info-r13 |
| OPTIONAL | -- Need ON | |
| ]], | | |
| [[ sps-Config-v14xy | | SPS-Config-v14xy |
| OPTIONAL | -- Need ON | |
| ]] | | |
| } | | |
| RadioResourceConfigDedicatedSCG-r12 ::= | | SEQUENCE { |
| drb-ToAddModListSCG-r12 | | DRB-ToAddModListSCG-r12 |
| OPTIONAL, | -- Need ON | |
| mac-MainConfigSCG-r12 | | MAC-MainConfig |
| OPTIONAL, | -- Need ON | |
| rlf-TimersAndConstantsSCG-r12 | | RLF-TimersAndConstantsSCG- |
| r12 | | |
| OPTIONAL, | -- Need ON | |

| | |
|---|---|
| ... | |
| } | |
| RadioResourceConfigDedicatedSCell-r10 ::= | SEQUENCE { |

-- UE specific configuration extensions applicable for an

| SCell | | |
|---|---|---|
| physicalConfigDedicatedSCell-r10 | | |
| PhysicalConfigDedicatedSCell-r10 | | OPTIONAL, -- Need ON |
| ..., | | |
| [[ mac-MainConfigSCell-r11 | | MAC-MainConfigSCell-r11 |
| OPTIONAL | -- Cond SCellAdd | |
| ]], | | |
| [[ naics-Info-r12 | | NAICS-AssistanceInfo-r12 |
| OPTIONAL | -- Need ON | |
| ]], | | |
| [[ neighCellsCRS-InfoSCell-r13 | | NeighCellsCRS-Info-r13 |
| OPTIONAL | -- Need ON | |
| ]] | | |
| } | | |
| SRB-ToAddModList ::= | | SEQUENCE (SIZE (1..2)) OF |
| SRB-ToAddMod | | |
| SRB-ToAddMod ::= | SEQUENCE { | |
| srb-Identity | | INTEGER (1..2), |
| rlc-Config | | CHOICE { |
| explicitValue | | RLC-Config, |
| defaultValue | | NULL |
| } OPTIONAL, | -- Cond Setup | |
| logicalChannelConfig | | CHOICE { |
| explicitValue | | LogicalChannelConfig, |
| defaultValue | | NULL |
| } OPTIONAL, | -- Cond Setup | |
| ... | | |
| } | | |
| DRB-ToAddModList ::= | | SEQUENCE (SIZE (1..maxDRB)) OF |
| DRB-ToAddMod | | |
| DRB-ToAddModListSCG-r12 ::= | | SEQUENCE (SIZE (1..maxDRB)) OF |
| DRB-ToAddModSCG-r12 | | |
| DRB-ToAddMod ::= | SEQUENCE { | |
| eps-BearerIdentity | | INTEGER (0..15) |
| OPTIONAL, | -- Cond DRB-Setup | |
| drb-Identity | | DRB-Identity, |
| pdcp-Config | | PDCP-Config |
| OPTIONAL, | -- Cond PDCP | |
| rlc-Config | | RLC-Config |
| OPTIONAL, | -- Cond SetupM | |
| logicalChannelIdentity | | INTEGER (3..10) |
| OPTIONAL, | -- Cond DRB-SetupM | |
| logicalChannelConfig | | LogicalChannelConfig |
| OPTIONAL, | -- Cond SetupM | |
| ..., | | |
| [[ drb-TypeChange-r12 | | ENUMERATED [toMCG] |
| OPTIONAL, | -- Need OP | |
| rlc-Config-v1250 | | RLC-Config-v1250 |
| OPTIONAL | -- Need ON | |
| ]], | | |
| [[ rlc-Config-v1310 | | RLC-Config-v1310 |
| OPTIONAL, | -- Need ON | |
| drb-TypeLWA-r13 | | BOOLEAN |
| OPTIONAL, | -- Need ON | |
| drb-TypeLWIP-r13 | | ENUMERATED [lwip, |
| | | lwip-DL-only, |
| | | lwip-UL-only, eutran] |
| OPTIONAL | -- Need ON | |
| ]], | | |
| [[ rlc-Config-v14xy | | RLC-Config-v14xy |
| OPTIONAL, | -- Need ON | |
| lwip-UL-Aggregation-r14 | | BOOLEAN |
| OPTIONAL, | -- Cond LWIP | |
| lwip-DL-Aggregation-r14 | | BOOLEAN |
| OPTIONAL, | -- Cond LWIP | |
| lwa-WLAN-AC-r14 | | ENUMERATED {ac-bk, ac-be, |
| | | ac-vi, ac-vo} |
| OPTIONAL | -- Need OP | |

]]
}

DRB-ToAddModSCG-r12 ::= SEQUENCE {

| drb-Identity-r12 | | DRB-Identity, |
|---|---|---|
| drb-Type-r12 | | CHOICE { |
| split-r12 | | NULL, |
| scg-r12 | | SEQUENCE { |
| eps-BearerIdentity-r12 | | INTEGER (0..15) |
| OPTIONAL, | -- Cond DRB-Setup | |
| pdcp-Config-r12 | | PDCP-Config |
| OPTIONAL | -- Cond PDCP-S | |
| } | | |
| } OPTIONAL, | -- Cond SetupS2 | |
| rlc-ConfigSCG-r12 | | RLC-Config |
| OPTIONAL, | -- Cond SetupS | |
| rlc-Config-v1250 | | RLC-Config-v1250 |
| OPTIONAL, | -- Need ON | |
| logicalChannelIdentitySCG-r12 | | INTEGER (3..10) |
| OPTIONAL, | -- Cond DRB-SetupS | |
| logicalChannelConfigSCG-r12 | | LogicalChannelConfig |
| OPTIONAL, | -- Cond SetupS | |
| ..., | | |
| [[ rlc-Config-v14xy | | RLC-Config-v14xy |
| OPTIONAL | -- Need ON | |

| | |
|---|---|
| ]] | |
| } | |
| DRB-ToReleaseList ::= SEQUENCE ( | |
| SIZE (1..maxDRB)) OF DRB-Identity | |
| MeasSubframePatternPCell-r10 ::= | CHOICE { |
| release | NULL, |
| setup | MeasSubframePattern-r10 |
| } | |
| NeighCellsCRS-Info-r11 ::= | CHOICE { |
| release | NULL, |
| setup | CRS-AssistanceInfoList-r11 |
| } | |

CRS-AssistanceInfoList-r11 ::= SEQUENCE (
SIZE (1..maxCellReport)) OF CRS-AssistanceInfo-r11

| | |
|---|---|
| CRS-AssistanceInfo-r11 ::= SEQUENCE { | |
| physCellId-r11 | PhysCellId, |
| antennaPortsCount-r11 | ENUMERATED {an1, an2, an4, |
| | spare1}, |
| mbsfn-SubframeConfigList-r11 | MBSFN-SubframeConfigList, |
| ... | |
| } | |
| NeighCellsCRS-Info-r13 ::= | CHOICE { |
| release | NULL, |
| setup | CRS-AssistanceInfoList-r13 |
| } | |
| CRS-AssistanceInfoList-r13 ::= | SEQUENCE ( |

SIZE (1..maxCellReport)) OF CRS-AssistanceInfo-r13

| CRS-AssistanceInfo-r13 ::= SEQUENCE { | | |
|---|---|---|
| physCellId-r13 | | PhysCellId, |
| antennaPortsCount-r13 | | ENUMERATED {an1, an2, an4, |
| | | spare1}, |
| mbsfn-SubframeConfigList-r13 | | MBSFN-SubframeConfigList |
| OPTIONAL, | -- Need ON | |
| ... | | |
| } | | |
| NAICS-AssistanceInfo-r12 ::= | | CHOICE { |
| release | | NULL, |
| setup | | SEQUENCE { |
| neighCellsToReleaseList-r12 | | NeighCellsToReleaseList- |
| r12 | | |
| OPTIONAL, | -- Need ON | |
| neighCellsToAddModList-r12 | | NeighCellsToAddModList- |
| r12 | | |
| OPTIONAL, | -- Need ON | |
| servCellp-a-r12 | | P-a |
| OPTIONAL, | -- Need ON | |

| | |
|---|---|
| } | |
| } | |
| NeighCellsToReleaseList-r12 ::= | SEQUENCE ( |

SIZE (1..maxNeighCell-r12)) OF PhysCellId

| | |
|---|---|
| NeighCellsToAddModList-r12 ::= | SEQUENCE ( |

SIZE (1..maxNeighCell-r12)) OF NeighCellsInfo-r12

| NeighCellsInfo-r12 ::= | | SEQUENCE { |
|---|---|---|
| physCellId-r12 | | PhysCellId, |
| p-b-r12 | | INTEGER (0..3), |
| crs-PortsCount-r12 | | ENUMERATED {n1, n2, n4, |
| spare}, | | |
| mbsfn-SubframeConfig-r12 | | MBSFN-SubframeConfigList |
| OPTIONAL, | -- Need ON | |

| | |
|---|---|
| p-aList-r12 | SEQUENCE ( |

SIZE (1..maxP-a-PerNeighCell-r12)) OF P-a,

| | |
|---|---|
| transmissionModeList-r12 | BIT STRING (SIZE(8)), |
| resAllocGranularity-r12 | INTEGER (1..4), |
| ... | |
| } | |

P-a ::= ENUMERATED {dB-6, dB-4dot77, dB-3, dB-1dot77,

| | |
|---|---|
| | dB0, dB1, dB2, dB3} |
| -- ASN1STOP | |

The following are field descriptions for RadioResourceConfigDedicated of Listing 8. crs-PortsCount is a parameter that represents the number of antenna ports for a cell-specific reference signal used by the signaled neighboring cell where n1 corresponds to 1 antenna port, n2 to 2 antenna ports etc.

In case of DC, the drb-Identity is unique within the scope of the UE 102. In other words an SCG DRB cannot use the same value as used for an MCG or split DRB. For a split DRB, the same identity is used for the MCG and SCG parts of the configuration.

When an SCG is configured, E-UTRAN configures at least one SCG or split DRB, as indicated by drb-ToAddModListSCG.

The drb-Type field indicates whether the DRB is split or a SCG DRB. E-UTRAN does not configure split and SCG DRBs simultaneously for the UE 102.

The drb-TypeChange field indicates that a split/SCG DRB is reconfigured to an MCG DRB. The E-UTRAN only signals the field in case the DRB type changes.

The drb-TypeLWA field indicates whether a DRB is (re)configured as an LWA DRB or an LWA DRB is reconfigured not to use WLAN resources. It is up to gNB 160 to ensure that the field indicating LWA bearer type is set to FALSE when the LWA bearer is no longer used (e.g., during handover or re-establishment where LWA configuration is released).

The drb-TypeLWIP field indicates whether a DRB is (re)configured to use a LWIP Tunnel in UL and DL (value lwip), DL only (value lwip-DL-only), UL only (value lwip-UL-only) or not to use LWIP Tunnel (value eutran).

The field logicalChannelConfig may be used to configure the logical channel parameters. For SRBs, a choice may be used to indicate whether the logical channel configuration is signaled explicitly or set to the default logical channel configuration for SRB1 as specified in 9.2.1.1 of TS 36.331 or for SRB2, as specified in 9.2.1.2 of TS 36.331. The field logicalChannelConfig is described further in connection with Listing 9.

The field logicalChannelIdentity may be used for the logical channel identity for both UL and DL.

For LWA bearers, the field lwa-WLAN-AC indicates the corresponding WLAN access category for uplink. AC-BK (value ac-bk) corresponds to Background access category, AC-BE (value ac-be) corresponds to Best Effort access category, AC-VI (value ac-vi) corresponds to Video access category and AC-VO (value ac-vo) corresponds to Voice access category as defined by IEEE 802.11-2012. This field is included only when ul-LWA-DRB-ViaWLAN is set to TRUE or ul-LWA-DataSplitThreshold is configured. If lwa-WLAN-AC is not configured, it is left up to the UE 102 to decide which IEEE 802.11 AC value to use when performing transmissions of packets for this DRB over WLAN in the uplink.

The fields lwip-DL-Aggregation and lwip-UL-Aggregation indicate whether LWIP is configured to utilize LWIP aggregation in DL or UL.

Although the ASN.1 includes a choice that is used to indicate whether the field mac-MainConfig is signaled explicitly or set to the default MAC main configuration as specified in 9.2.2, EUTRAN does not apply a “defaultValue.”

The field mbsfn-SubframeConfig defines the MBSFN subframe configuration used by the signaled neighboring cell. If absent, the UE 102 may assume no MBSFN configuration for the neighboring cell.

The field measSubframePatternPCell may indicate a time domain measurement resource restriction pattern for the PCell measurements (e.g., Reference Signal Received Power (RSRP), Reference Signal Received Quality (RSRQ) and the radio link monitoring).

The fields neighCellsCRS-Info, neighCellsCRS-InfoSCell, and neighCellsCRS-InfoPSCell contain assistance information used by the UE 102 to mitigate interference from a Cell Specific Reference Signal (CRS) while performing a radio resource management (RRM), radio link monitoring (RLM) and/or channel state information (CSI) measurement, data demodulation or DL control channel demodulation. When the received CRS assistance information is for a cell with CRS non-colliding with that of the CRS of the cell to measure, the UE 102 may use the CRS assistance information to mitigate CRS interference. When the received CRS assistance information is for a cell with CRS colliding with that of the CRS of the cell to measure, the UE 102 may use the CRS assistance information to mitigate CRS interference RRM/RLM (as specified in TS 36.133) and for CSI (as specified in TS 36.101) on the subframes indicated by measSubframePatternPCell, measSubframePatternConfigNeigh, csi-MeasSubframeSed if configured, and the CSI subframe set 1 if csi-MeasSubframeSets-r12 is configured. The UE 102 may use CRS assistance information to mitigate CRS interference from the cells in the CRS-AssistanceInfoList for the demodulation purpose or DL control channel demodulation as specified in TS 36.101. EUTRAN does not configure neighCellsCRS-Info-r11 or neighCellsCRS-Info-r13 if eimta-MainConfigPCell-r12 is configured.

The field neighCellsToAddModList contains assistance information used by the UE 102 to cancel and suppress interference of a neighboring cell. If this field is present for a neighboring cell, the UE 102 may assume that the transmission parameters listed in the sub-fields are used by the neighboring cell. If this field is present for a neighboring cell, the UE 102 may assume the neighbor cell is subframe and System Frame Number (SFN) synchronized to the serving cell, has the same system bandwidth, UL/DL and special subframe configuration, and cyclic prefix length as the serving cell.

The field p-aList indicates the restricted subset of power offset for QPSK, 16QAM, and 64QAM PDSCH transmissions for the neighboring cell by using the parameter P_{A}, see TS 36.213. Value dB-6 corresponds to −6 dB, dB-4dot77 corresponds to −4.77 dB, etc.

The parameter p-b (P_{B}) indicates the cell-specific ratio used by the signaled neighboring cell, see TS 36.213 [23, Table 5.2-1].

The field physicalConfigDedicated may be the default dedicated physical configuration, as specified in TS 36.331 9.2.4.

The field resAllocGranularity indicates the resource allocation and precoding granularity in PRB pair level of the signaled neighboring cell, see TS 36.213 [23, 7.1.6].

The field rlc-Config may be used for RLC configuration. For SRBs a choice is used to indicate whether the RLC configuration is signaled explicitly or set to the values defined in the default RLC configuration for SRB1 in 9.2.1.1 or for SRB2 in 9.2.1.2. RLC AM is the only applicable RLC mode for SRB1 and SRB2. E-UTRAN does not reconfigure the RLC mode of DRBs except when a full configuration option is used, and may reconfigure the RLC SN field size and the AM RLC LI field size only upon handover within E-UTRA or upon the first reconfiguration after RRC connection re-establishment or upon SCG Change for SCG and split DRBs.

The field servCellp-a indicates the power offset for QPSK C-RNTI based PDSCH transmissions used by the serving cell, see TS 36.213 [23, 5.2]. Value dB-6 corresponds to −6 dB, dB-4dot77 corresponds to −4.77 dB, etc.

The field sps-Config may be used for SPS configuration. The default SPS configuration is specified in 9.2.3. Except for handover or releasing SPS for MCG, E-UTRAN does not reconfigure sps-Config for MCG when there is a configured downlink assignment or a configured uplink grant for MCG (see TS 36.321 [6]). Except for SCG change or releasing SPS for SCG, E-UTRAN does not reconfigure sps-Config for SCG when there is a configured downlink assignment or a configured uplink grant for SCG (see TS 36.321 [6]).

With the field srb-Identity, value 1 is applicable for SRB1 only and value 2 is applicable for SRB2 only.

The field transmissionModeList indicates a subset of transmission mode 1, 2, 3, 4, 6, 8, 9, 10, for the signaled neighboring cell for which NeighCellsInfo applies. When TM10 is signaled, other signaled transmission parameters in NeighCellsInfo are not applicable to up to 8 layer transmission scheme of TM10. E-UTRAN may indicate TM9 when TM10 with QCL type A and DMRS scrambling with n_{ID}⁽ⁱ⁾=n_{ID}^{cell} in TS 36.211 [21, 6.10.3.1] is used in the signaled neighbor cell and TM9 or TM10 with QCL type A and DMRS scrambling with n_{ID}⁽ⁱ⁾=n_{ID}^{cell} in TS 36.211 [21, 6.10.3.1] is used in the serving cell. UE behavior with NAICS when TM10 is used is only defined when QCL type A and DMRS scrambling with n_{ID}⁽ⁱ⁾=n_{ID}^{cell} in TS 36.211 [21, 6.10.3.1] is used for the serving cell and all signaled neighbor cells. The first/leftmost bit is for transmission mode 1, the second bit is for transmission mode 2, and so on.

The conditional presence of fields in Listing 8 is explained herein. The conditional presence CRSIM indicates that the field is optionally present (need ON) if neighCellsCRS-Info-r11 is not present; otherwise it is not present.

The conditional presence DRB-Setup indicates that the field is mandatory present if the corresponding DRB is being set up; otherwise it is not present.

The conditional presence DRB-SetupM indicates the field is mandatory present upon setup of MCG or split DRB. The field is optionally present (Need ON) upon change from SCG to MCG DRB; otherwise it is not present.

The conditional presence DRB-SetupS indicates the field is mandatory present upon setup of SCG or split DRB, or upon change from MCG to split DRB. The field is optionally present (Need ON) upon change from MCG to SCG DRB; otherwise it is not present.

The conditional presence HO-Conn indicates the field is mandatory present in case of handover to E-UTRA or when the fullConfig is included in the RRCConnectionReconfiguration message or in case of RRC connection establishment (excluding RRConnectionResume); otherwise the field is optionally present (need ON). Upon connection establishment/re-establishment only SRB1 is applicable (excluding RRConnectionResume).

The conditional presence HO-toEUTRA indicates the field is mandatory present in case of handover to E-UTRA or when the fullConfig is included in the RRCConnectionReconfiguration message. In case of RRC connection establishment (excluding RRConnectionResume) and RRC connection re-establishment, the field is not present; otherwise the field is optionally present (need ON).

The conditional presence HO-toEUTRA2 indicates the field is mandatory present in case of handover to E-UTRA or when the fullConfig is included in the RRCConnectionReconfiguration message; otherwise the field is optionally present (need ON).

The conditional presence LWIP indicates the field is optionally present (Need ON) if drbTypeLWIP-r13 is not set to eutran; otherwise it is not present and the UE 102 may delete any existing value for this field.

The conditional presence PDCP indicates the field is mandatory present if the corresponding DRB is being setup. The field is optionally present (need ON) upon reconfiguration of the corresponding split DRB or LWA DRB, upon the corresponding DRB type change from split to MCG bearer, upon the corresponding DRB type change from MCG to split bearer or LWA bearer, upon the corresponding DRB type change from LWA to LTE only bearer, upon handover within E-UTRA and upon the first reconfiguration after re-establishment but in all these cases only when fullConfig is not included in the RRCConnectionReconfiguration message; otherwise it is not present.

The conditional presence PDCP-S indicates the field is mandatory present if the corresponding DRB is being setup. The field is optionally present (need ON) upon SCG change; otherwise it is not present.

The conditional presence RLC-Setup indicates this field is optionally present if the corresponding DRB is being setup (need ON); otherwise it is not present.

The conditional presence SCellAdd indicates the field is optionally present (need ON) upon SCell addition; otherwise it is not present.

The conditional presence Setup indicates the field is mandatory present if the corresponding SRB/DRB is being setup; otherwise the field is optionally present (need ON).

The conditional presence SetupM indicates the field is mandatory present upon setup of an MCG or split DRB; otherwise the field is optionally present (need ON).

The conditional presence SetupS indicates the field is mandatory present upon setup of an SCG or split DRB, as well as upon change from MCG to split DRB; otherwise the field is optionally present (need ON).

The conditional presence SetupS2 indicates the field is mandatory present upon setup of an SCG or split DRB, as well as upon change from MCG to split or SCG DRB. For an SCG DRB the field is optionally present (need ON). Otherwise the field is not present.

Radio resource control information elements are also described herein. The IE LogicalChannelConfig may be used to configure the logical channel parameters, as illustrated in Listing 9.

Listing 9

-- ASN1START

| LogicalChannelConfig ::= | | SEQUENCE { |
|---|---|---|
| ul-SpecificParameters | | SEQUENCE { |
| priority | | INTEGER (1..16), |
| prioritisedBitRate | | ENUMERATED { |
| | | kBps0, kBps8, kBps16, |
| | | kBps32, kBps64, kBps128, |
| | | kBps256, infinity, |
| | | kBps512-v1020, |
| | | kBps1024-v1020, |
| | | kBps2048-v1020, spare5, |
| | | spare4, spare3, spare2, |
| | | spare1}, |
| bucketSizeDuration | | ENUMERATED { |
| | | ms50, ms100, ms150, |
| ms300, | | |
| | | ms500, ms1000, spare2, |
| | | spare1}, |
| numerology supported | | INETGER (1,2,3...N), |
| numerology instances | | ENUMERATED {15KHz, 30KHz, |
| | | 6kHz,.., (2nx 60KHz) }, |
| logicalChannelGroup | | INTEGER (0..3) |
| OPTIONAL | -- Need OR | |
| } OPTIONAL, | -- Cond UL | |
| ..., | | |
| [[ logicalChannelSR-Mask-r9 | | ENUMERATED {setup} |
| OPTIONAL | -- Cond Srmask | |
| ]], | | |
| [[ logicalChannelSR-Prohibit-r12 | | BOOLEAN |
| OPTIONAL | -- Need ON | |
| ]], | | |
| [[ laa-Allowed-r14 | | BOOLEAN |
| OPTIONAL, | -- Need ON | |
| bitRateQueryProhibitTimer-r14 | | ENUMERATED { |
| | | s0, s0dot4, s0dot8, |
| | | s1dot6, s3, s6, s12, |
| | | s30} |
| OPTIONAL | --Need OR | |

]]
}
-- ASN1STOP

The following are field descriptions for LogicalChannelConfig of Listing 9. The field bitRateQueryProhibitTimer is a timer used for a bit rate recommendation query in TS 36.321, in seconds. The value s0 means 0s, s0dot4 means 0.4s and so on.

The field bucketSizeDuration is the Bucket Size Duration for logical channel prioritization in TS 36.321. The value is in milliseconds. Value ms50 corresponds to 50 ms, ms100 corresponds to 100 ms, and so on.

The field laa-Allowed indicates whether the data of a logical channel is allowed to be transmitted via UL of LAA SCells. The value TRUE indicates that the logical channel is allowed to be sent via UL of LAA SCells. The value FALSE indicates that the logical channel is not allowed to be sent via UL of LAA SCells.

The field logicalChannelGroup is a mapping of logical channel to logical channel group for reporting in TS 36.321.

The field logicalChannelSR-Mask is a controlling SR triggering on a logical channel basis when an uplink grant is configured.

The field logicalChannelSR-Prohibit value TRUE indicates that the logicalChannelSR-ProhibitTimer is enabled for the logical channel E-UTRAN only (optionally) configures the field (i.e., indicates value TRUE) if logicalChannelSR-ProhibitTimer is configured.

The field numerology (sub-carrier spacing) supported indicates the number of sTTI and numerology (sub-carrier spacing)s supported (e.g., 1, 2, 3).

The field numerology (sub-carrier spacing) instances indicates specific the channel spacing supported (e.g., 15 KHz, 30 KHz, 60 KHz).

The field prioritisedBitRate is the prioritized bit rate for logical channel prioritization in TS 36.321. The value is in kilobytes/second. A value kBps0 corresponds to 0 kB/second, kBps8 corresponds to 8 kB/second, kBps16 corresponds to 16 kB/second, and so on. Infinity is the only applicable value for SRB1 and SRB2.

The field priority is the logical channel priority in TS 36.321. The value may be an integer.

The SRmask field is optionally present if ul-SpecificParameters is present, need OR; otherwise it is not present. The UL field is mandatory present for UL logical channels; otherwise it is not present.

Another example of a LogicalChannelConfig IE that may be used to configure the logical channel parameters is illustrated in Listing 10.

Listing 10

-- ASN1START
-- TAG-LOGICAL-CHANNEL-CONFIG-START

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, |

kBps16, kBps32, kBps64, kBps128, kBps256, kBps512,

kBps1024, kBps2048, kBps4096,

kBps8192, kBps16384, kBps32768, kBps65536, infinity},

| | |
|---|---|
| bucketSizeDuration | ENUMERATED {ms50, ms100, |

ms150, ms300, ms500, ms1000, spare2, spare1},

| | |
|---|---|
| allowedServingCells | SEQUENCE (SIZE |

(1..maxNrofServingCells-1)) OF ServCellIndex

| | |
|---|---|
| OPTIONAL, | -- Need R |

| | |
|---|---|
| allowedSCS-List | SEQUENCE (SIZE (1..maxSCSs)) |
| OF SubcarrierSpacing | OPTIONAL, -- Need R |
| maxPUSCH-Duration | ENUMERATED { ms0p02, ms0p04, |

ms0p0625, ms0p125, ms0p25, ms0p5, spare2, spare1 }

| OPTIONAL, | -- Need R | |
|---|---|---|
| configuredGrantType1Allowed | | ENUMERATED {true} |
| OPTIONAL, | -- Need R | |
| logicalChannelGroup | | INTEGER (0..maxLCG-ID) |
| OPTIONAL, | -- Need R | |
| schedulingRequestID | | SchedulingRequestId |
| OPTIONAL, | -- Need R | |

| | |
|---|---|
| logicalChannelSR-Mask | BOOLEAN, |

logicalChannelSR-DelayTimerApplied BOOLEAN

| } | |
|---|---|
| OPTIONAL, | -- Cond UL |

```
  -- other parameters
  ...
}
```

-- TAG-LOGICAL-CHANNEL-CONFIG-STOP

-- ASN1STOP

The following are field descriptions for LogicalChannelConfig of Listing 10. If the field allowedSCS-List is present, UL MAC SDUs from this logical channel can only be mapped to the indicated numerology. Otherwise, UL MAC SDUs from this logical channel can be mapped to any configured numerology.

If the field allowedServingCells is present UL MAC SDUs from this logical channel can only be mapped to the serving cells indicated in this list. Otherwise, UL MAC SDUs from this logical channel can be mapped to any configured serving cell of this cell group.

For the field bucketSizeDuration, the value is in ms. ms50 corresponds to 50 ms, ms100 corresponds to 100 ms, and so on.

If the field configuredGrantType1Allowed is present, UL MAC SDUs from this logical channel can be transmitted on a configured grant type 1.

The field logicalChannelGroup is an ID of the logical channel group, which the logical channel belongs to.

The field logicalChannelSR-Mask indicates whether SR masking is configured for this logical channel.

The field logicalChannelSR-DelayTimerApplied indicates whether to apply the delay timer for SR transmission for this logical channel Set to FALSE if logicalChannelSR-DelayTimer is not included in BSR-Config.

If the field maxPUSCH-Duration is present, UL MAC SDUs from this logical channel can only be transmitted using uplink grants that result in a PUSCH duration shorter than or equal to the duration indicated by this field. Otherwise, UL MAC SDUs from this logical channel can be transmitted using an uplink grant resulting in any PUSCH duration.

The field priority indicates the logical channel priority.

For the field prioritisedBitRate, the value is in kiloBytes/s. 0 kBps corresponds to 0, 8 kBps corresponds to 8 kiloBytes/s, 16 kBps corresponds to 16 kiloBytes/s, and so on. For SRBs, the value can only be set to infinity.

If the field schedulingRequestId is present, it indicates the scheduling request configuration applicable for this logical channel.

The conditional presence “UL” indicates that the field is mandatory present for a logical channel with uplink if it serves DRB. The field is optionally present for a logical channel with uplink if it serves an SRB. Otherwise the field is not present.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB numerology (sub-carrier spacing) information module 194. The gNB numerology (sub-carrier spacing) information module 194 may add and modify SRBs and DRBs including numerology (sub-carrier spacing) information in LTE and NR as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

FIG. 2 illustrates an example of a successful Radio Resource Control (RRC) connection establishment procedure. A UE 202 may be in communication with an EUTRAN 260 (e.g., an eNB or gNB 160).

The UE 202 may send 201 an RRCConnectionRequest to the EUTRAN 260. The EUTRAN 260 may send 203 an RRCConnectionSetup to the UE 202. The UE 202 may reply by sending 205 a RRCConnectionSetupComplete to the EUTRAN 260.

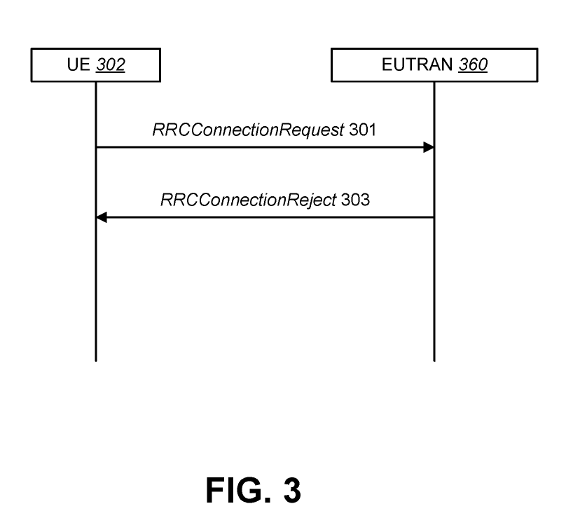

FIG. 3 illustrates an example of a network rejection in a RRC connection establishment procedure. A UE 302 may be in communication with an EUTRAN 360 (e.g., an eNB or gNB 160).

The UE 302 may send 301 an RRCConnectionRequest to the EUTRAN 360. The EUTRAN 360 may send 303 an RRCConnectionReject to the UE 302.

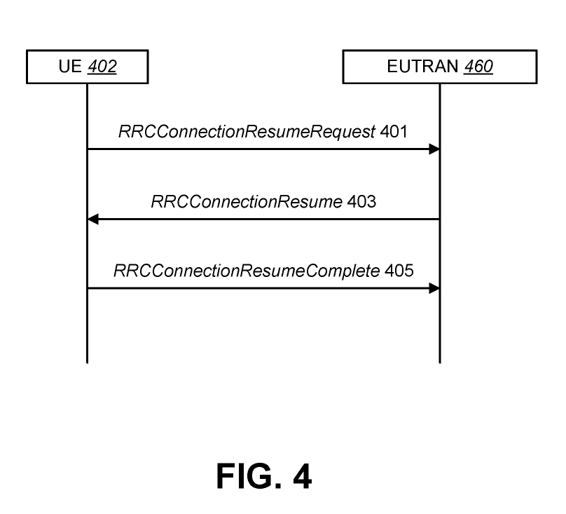

FIG. 4 illustrates an example of a successful RRC connection resume procedure. A UE 402 may be in communication with an EUTRAN 460 (e.g., an eNB or gNB 160).

The UE 402 may send 401 an RRCConnectionResumeRequest to the EUTRAN 460. The EUTRAN 460 may send 403 an RRCConnectionResume to the UE 402. The UE 402 may reply by sending 405 a RRCConnectionResumeComplete to the EUTRAN 460.

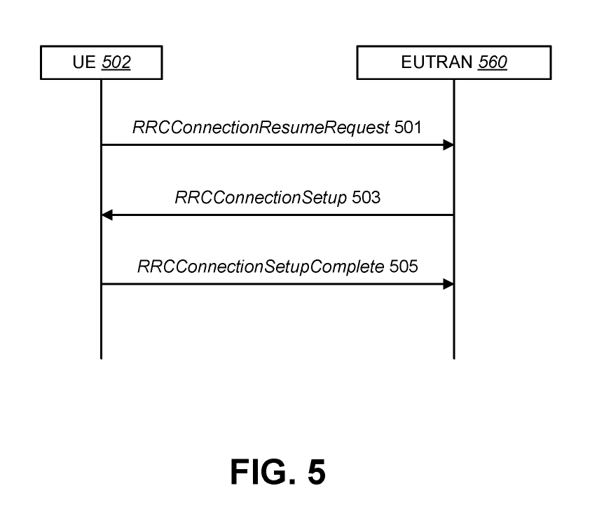

FIG. 5 illustrates an example of a successful RRC connection resume fallback to RRC connection establishment procedure. A UE 502 may be in communication with an EUTRAN 560 (e.g., an eNB or gNB 160).

The UE 502 may send 501 an RRCConnectionResumeRequest to the EUTRAN 560. The EUTRAN 560 may send 503 an RRCConnectionSetup to the UE 502. The UE 202 may reply by sending 505 a RRCConnectionSetupComplete to the EUTRAN 560.

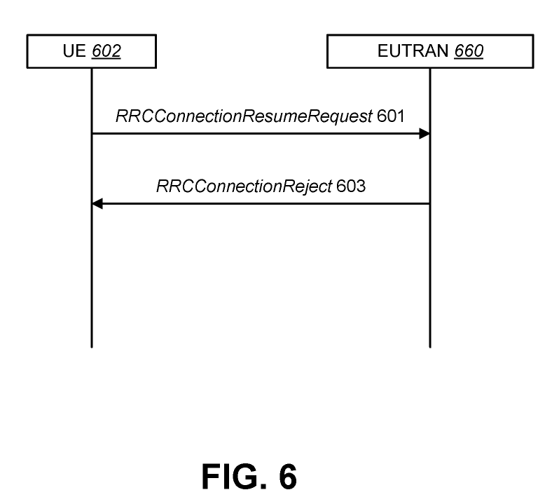

FIG. 6 illustrates an example of a network rejection or release in a RRC connection resume procedure. A UE 602 may be in communication with an EUTRAN 660 (e.g., an eNB or gNB 160).

The UE 602 may send 601 an RRCConnectionResumeRequest to the EUTRAN 660. The EUTRAN 660 may send 603 an RRCConnectionReject to the UE 602.

FIG. 7 illustrates an example of a successful RRC connection reconfiguration procedure. A UE 702 may be in communication with an EUTRAN 760 (e.g., an eNB or gNB 160).

The EUTRAN 760 may send 701 an RRCConnectionReconfiguration to the UE 702. The UE 702 may send 703 an RRCConnectionReconfigurationComplete to the UE 702.

FIG. 8 illustrates an example of a failure in a RRC connection reconfiguration procedure. A UE 802 may be in communication with an EUTRAN 860 (e.g., an eNB or gNB 160).

The EUTRAN 860 may send 801 an RRCConnectionReconfiguration to the UE 802. If the RRC connection reconfiguration fails, the UE 802 and the EUTRAN 860 may perform 803 an RRC connection re-establishment procedure.

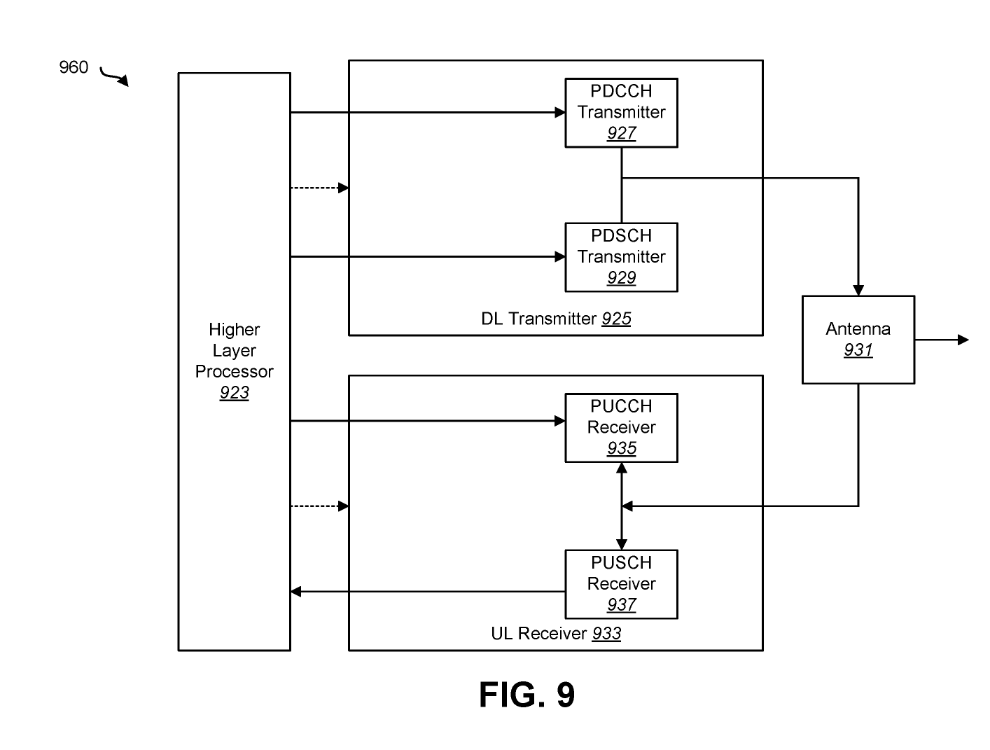

FIG. 9 is a block diagram illustrating one implementation of an gNB 960. The gNB 960 may include a higher layer processor 923, a DL transmitter 925, a UL receiver 933, and one or more antenna 931. The DL transmitter 925 may include a PDCCH transmitter 927 and a PDSCH transmitter 929. The UL receiver 933 may include a PUCCH receiver 935 and a PUSCH receiver 937.

The higher layer processor 923 may manage physical layer's behaviors (the DL transmitter's and the UL receiver's behaviors) and provide higher layer parameters to the physical layer. The higher layer processor 923 may obtain transport blocks from the physical layer. The higher layer processor 923 may send/acquire higher layer messages such as an RRC message and MAC message to/from a UE's higher layer. The higher layer processor 923 may provide the PDSCH transmitter transport blocks and provide the PDCCH transmitter transmission parameters related to the transport blocks.

The DL transmitter 925 may multiplex downlink physical channels and downlink physical signals (including reservation signal) and transmit them via transmission antennas 931. The UL receiver 933 may receive multiplexed uplink physical channels and uplink physical signals via receiving antennas 931 and de-multiplex them. The PUCCH receiver 935 may provide the higher layer processor 923 uplink control information (UCI). The PUSCH receiver 937 may provide the higher layer processor 923 received transport blocks.

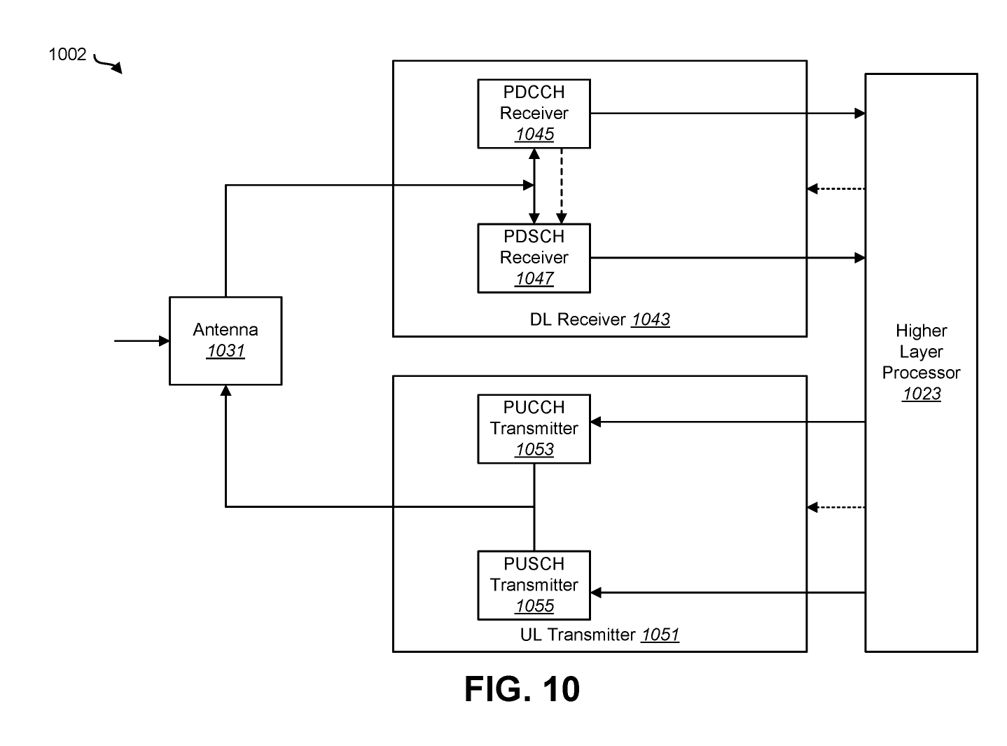

FIG. 10 is a block diagram illustrating one implementation of a UE 1002. The UE 1002 may include a higher layer processor 1023, a UL transmitter 1051, a DL receiver 1043, and one or more antenna 1031. The UL transmitter 1051 may include a PUCCH transmitter 1053 and a PUSCH transmitter 1055. The DL receiver 1043 may include a PDCCH receiver 1045 and a PDSCH receiver 1047.

The higher layer processor 1023 may manage physical layer's behaviors (the UL transmitter's and the DL receiver's behaviors) and provide higher layer parameters to the physical layer. The higher layer processor 1023 may obtain transport blocks from the physical layer. The higher layer processor 1023 may send/acquire higher layer messages such as an RRC message and MAC message to/from a UE' s higher layer. The higher layer processor 1023 may provide the PUSCH transmitter transport blocks and provide the PUCCH transmitter 1053 UCI.

The DL receiver 1043 may receive multiplexed downlink physical channels and downlink physical signals via receiving antennas 1031 and de-multiplex them. The PDCCH receiver 1045 may provide the higher layer processor 1023 downlink control information (DCI). The PDSCH receiver 1047 may provide the higher layer processor 1023 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

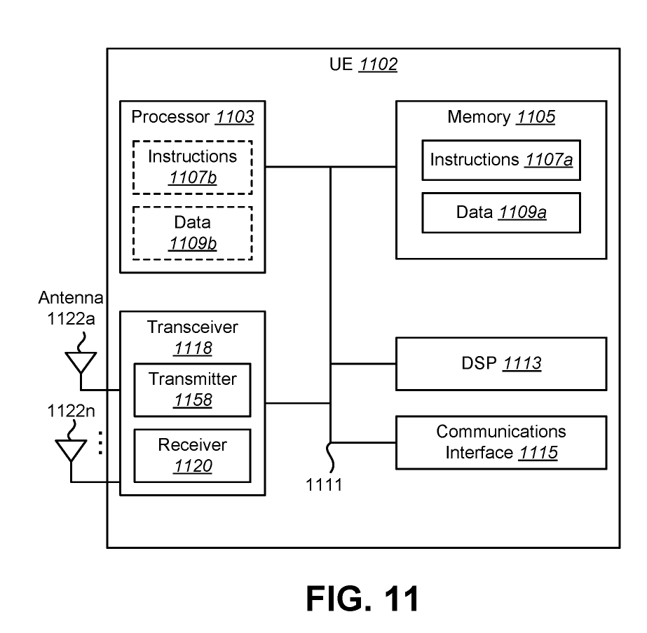

FIG. 11 illustrates various components that may be utilized in a UE 1102. The UE 1102 described in connection with FIG. 11 may be implemented in accordance with the UE 102 described in connection with FIG. 1. The UE 1102 includes a processor 1103 that controls operation of the UE 1102. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include non-volatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described above.

The UE 1102 may also include a housing that contains one or more transmitters 1158 and one or more receivers 1120 to allow transmission and reception of data. The transmitter(s) 1158 and receiver(s) 1120 may be combined into one or more transceivers 1118. One or more antennas 1122a-n are attached to the housing and electrically coupled to the transceiver 1118.

The various components of the UE 1102 are coupled together by a bus system 1111, which may include a power bus, a control signal bus and a status signal bus, in addition to a data bus. However, for the sake of clarity, the various buses are illustrated in FIG. 11 as the bus system 1111. The UE 1102 may also include a digital signal processor (DSP) 1113 for use in processing signals. The UE 1102 may also include a communications interface 1115 that provides user access to the functions of the UE 1102. The UE 1102 illustrated in FIG. 11 is a functional block diagram rather than a listing of specific components.

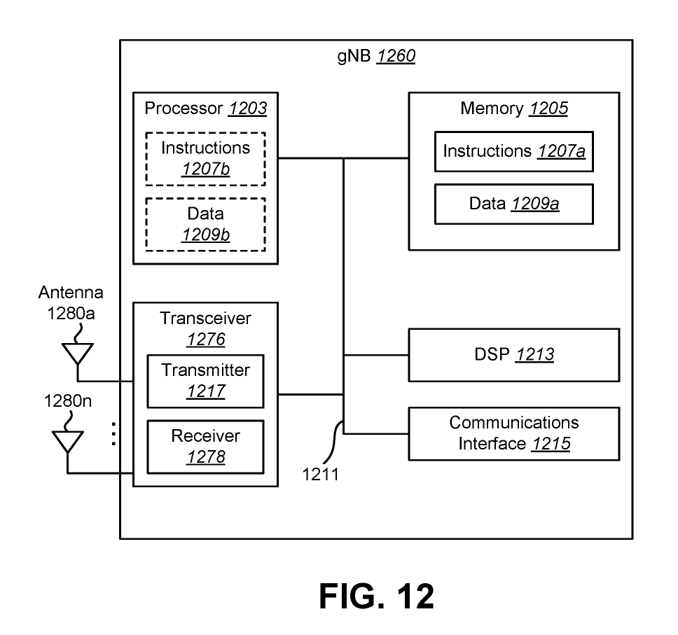

FIG. 12 illustrates various components that may be utilized in a gNB 1260. The gNB 1260 described in connection with FIG. 12 may be implemented in accordance with the gNB 160 described in connection with FIG. 1. The gNB 1260 includes a processor 1203 that controls operation of the gNB 1260. The processor 1203 may also be referred to as a central processing unit (CPU). Memory 1205, which may include read-only memory (ROM), random access memory (RAM), a combination of the two or any type of device that may store information, provides instructions 1207a and data 1209a to the processor 1203. A portion of the memory 1205 may also include non-volatile random access memory (NVRAM). Instructions 1207b and data 1209b may also reside in the processor 1203. Instructions 1207b and/or data 1209b loaded into the processor 1203 may also include instructions 1207a and/or data 1209a from memory 1205 that were loaded for execution or processing by the processor 1203. The instructions 1207b may be executed by the processor 1203 to implement the methods described above.

The gNB 1260 may also include a housing that contains one or more transmitters 1217 and one or more receivers 1278 to allow transmission and reception of data. The transmitter(s) 1217 and receiver(s) 1278 may be combined into one or more transceivers 1276. One or more antennas 1280a-n are attached to the housing and electrically coupled to the transceiver 1276.

The various components of the gNB 1260 are coupled together by a bus system 1211, which may include a power bus, a control signal bus and a status signal bus, in addition to a data bus. However, for the sake of clarity, the various buses are illustrated in FIG. 12 as the bus system 1211. The gNB 1260 may also include a digital signal processor (DSP) 1213 for use in processing signals. The gNB 1260 may also include a communications interface 1215 that provides user access to the functions of the gNB 1260. The gNB 1260 illustrated in FIG. 12 is a functional block diagram rather than a listing of specific components.

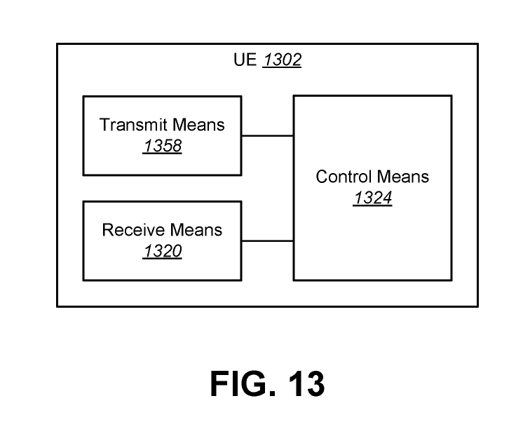

FIG. 13 is a block diagram illustrating one implementation of a UE 1302 in which systems and methods for adding and modifying SRBs and DRBs that include numerology (sub-carrier spacing) information may be implemented. The UE 1302 includes transmit means 1358, receive means 1320 and control means 1324. The transmit means 1358, receive means 1320 and control means 1324 may be configured to perform one or more of the functions described in connection with FIG. 1 above. FIG. 11 above illustrates one example of a concrete apparatus structure of FIG. 13. Other various structures may be implemented to realize one or more of the functions of FIG. 1. For example, a DSP may be realized by software.

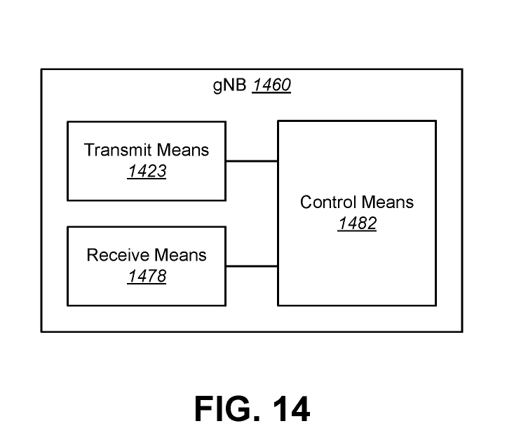

FIG. 14 is a block diagram illustrating one implementation of a gNB 1460 in which systems and methods for adding and modifying SRBs and DRBs that include numerology (sub-carrier spacing) information may be implemented. The gNB 1460 includes transmit means 1417, receive means 1478 and control means 1482. The transmit means 1417, receive means 1478 and control means 1482 may be configured to perform one or more of the functions described in connection with FIG. 1 above. FIG. 12 above illustrates one example of a concrete apparatus structure of FIG. 14. Other various structures may be implemented to realize one or more of the functions of FIG. 1. For example, a DSP may be realized by software.

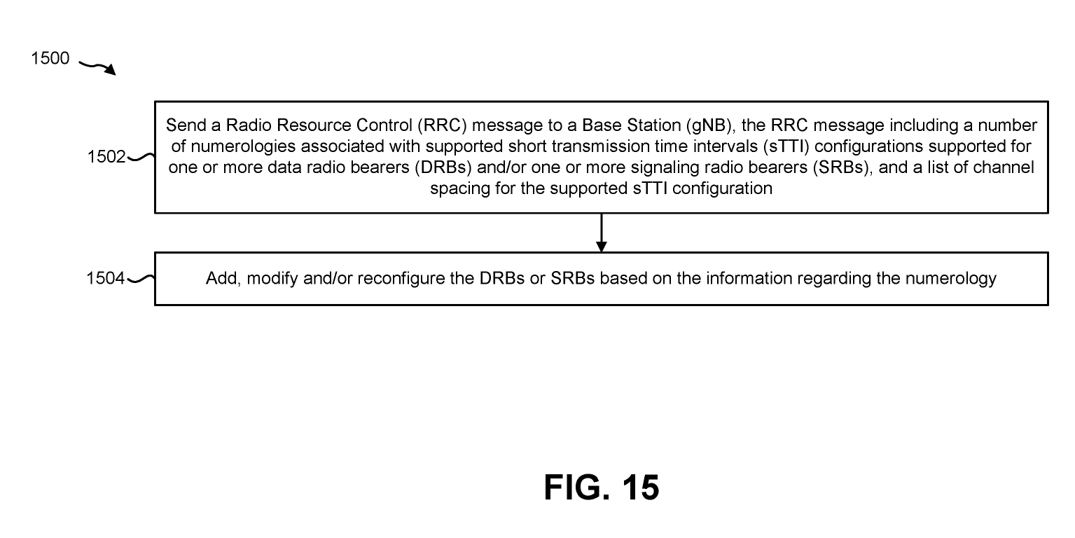

FIG. 15 is a flow diagram illustrating a method 1500 for adding and modifying signaling radio bearers (SRBs) and data radio bearers (DRBs) that include numerology (sub-carrier spacing) information.

A UE 102 may send 1502 a Radio Resource Control (RRC) message to a Base Station (gNB) 160. The RRC message may include a number of numerologies associated with supported short transmission time intervals (sTTI and numerology (sub-carrier spacing)) configurations supported for one or more data radio bearers (DRBs) and/or one or more signaling radio bearers (SRBs). The RRC message may also include a list of channel spacing for the supported sTTI configuration.

The information regarding the numerology (sub-carrier spacing) may be included in a Logical Channel Configuration (i.e., logicalChannelConfig) information element (IE).

The UE 102 may add, modify and/or reconfigure 1504 the DRBs or SRBs based on the information regarding the numerology (sub-carrier spacing).

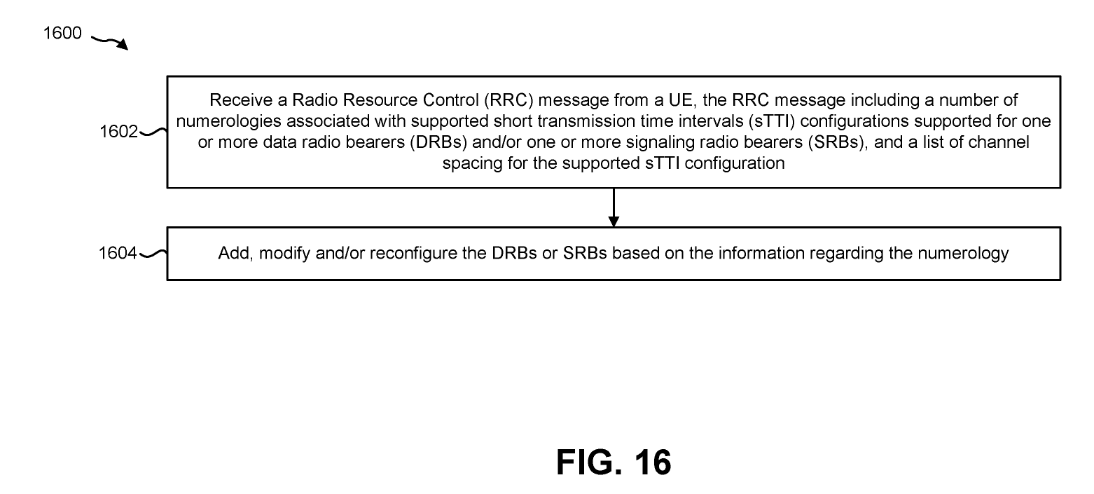

FIG. 16 is a flow diagram illustrating another method 1600 for adding and modifying signaling radio bearers (SRBs) and data radio bearers (DRBs) that include numerology (sub-carrier spacing) information.

A Base Station (gNB) 160 may receive 1602 a Radio Resource Control (RRC) message from a UE 102. The RRC message may include a number of numerologies associated with supported short transmission time intervals (sTTI and numerology (sub-carrier spacing)) configurations supported for one or more data radio bearers (DRBs) and/or one or more signaling radio bearers (SRBs). The RRC message may also include a list of channel spacing for the supported sTTI and numerology (sub-carrier spacing) configuration.

The information regarding the numerology (sub-carrier spacing) may be included in a Logical Channel Configuration (i.e., logicalChannelConfig) information element (IE).

The gNB 160 may add, modify and/or reconfigure 1604 the DRBs or SRBs based on the information regarding the numerology (sub-carrier spacing).

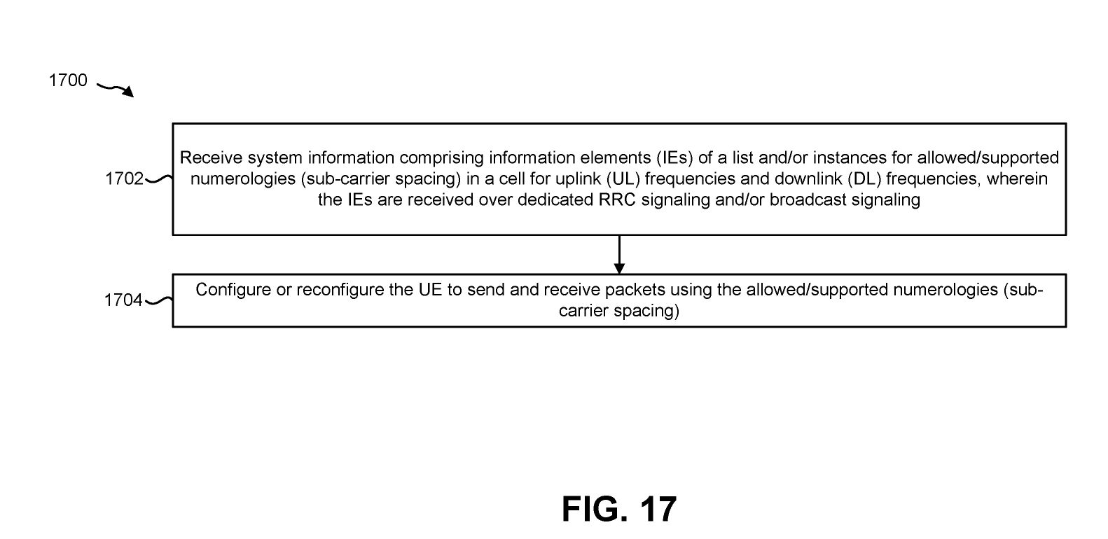

FIG. 17 is flow diagram illustrating another method 1700 for adding and modifying signaling radio bearers (SRBs) and data radio bearers (DRBs) that include numerology (sub-carrier spacing) information.

The UE 102 may receive 1702 system information that includes information elements (IEs) of a list and/or instances for allowed and/or supported numerologies (sub-carrier spacing) in a cell for uplink (UL) frequencies and downlink (DL) frequencies. The IEs may be received over dedicated RRC signaling and/or broadcast signaling.

The UE 102 may configure 1704 or reconfigure the UE to send and receive packets using the allowed/supported numerologies (sub-carrier spacing).

The IEs of the list and/or instances for allowed/supported numerologies (sub-carrier spacing) may include one or more supported/allowed instances numerologies (sub-carrier spacing) IEs or numerology instances comprising 15 kilohertz (kHz), 30 kHz, 60 kHz, 120 kHz, or 240 kHz. A number of numerology (carrier spacing) supported/allowed IE, or a numerology (sub-carrier spacing) list comprising an integer number (1-N) may also be included in the IEs of the list and/or instances for allowed/supported numerologies (sub-carrier spacing). N is a maximum number of numerologies allowed/supported as configured by a base station (gNB) 160.

In an example, the UE 102 may receive an RRC message that includes information elements (IEs) including a list and/or instances of the allowed/supported numerologies (sub-carrier spacing) for configuration of one or more of the following: a signaling radio bearer (SRB), a data radio bearer (DRB), or measurement configurations and a measurements report for inter/intra-frequency measurements comprising the allowed/supported list and/or instances of numerologies (sub-carrier spacing). The UE 102 may configure or reconfigure the UE 102 to send and receive packets using the indicated list and/or instances of the allowed/supported numerologies (sub-carrier spacing).

The UE 102 may perform measurements using the list and/or instances of supported/allowed numerology. The UE 102 may report these measurements as configured.

The RRC message may include one or more of the following: an RRCConnectionSteup message, an RRCConnectionReconfiguration message, an RRCConnectionResume message, or an RRCConnectionRe-Establishment message.

The information elements (IEs) of the list and/or instances for allowed/supported numerologies (sub-carrier spacing) may be included in one or more of the following radio resource control/configuration IEs: a logical channel configuration IE, a measurement configuration IE, downlink and uplink frequency information IEs, operational system bandwidth IEs, or configured uplink grants IEs.

The allowed/supported numerology used for UL frequencies may be configured for physical uplink control channel (PUCCH) and/or physical uplink shared channel (PUSCH). The allowed/supported numerology used for DL frequencies may be configured for physical downlink control channel (PDCCH) and/or physical downlink shared channel (PDSCH).

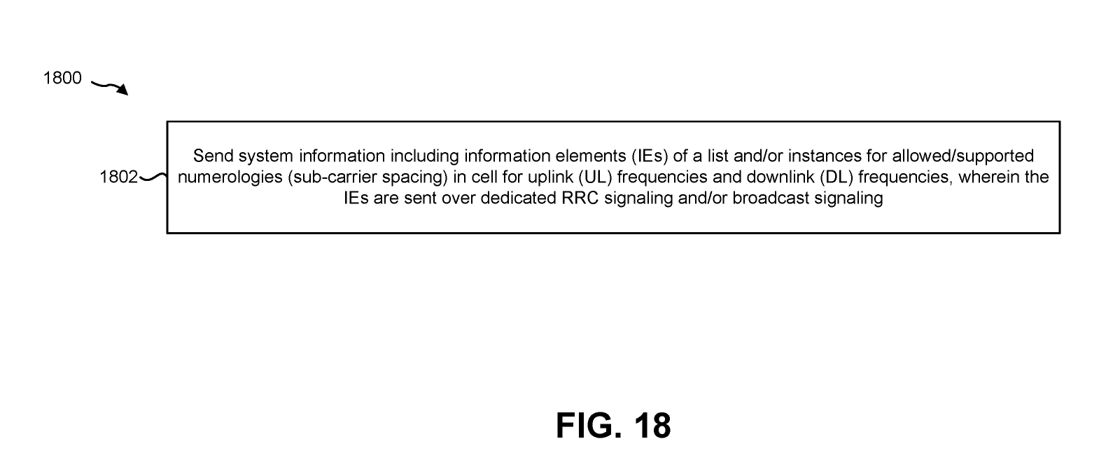

FIG. 18 is a flow diagram illustrating yet another method 1800 for adding and modifying signaling radio bearers (SRBs) and data radio bearers (DRBs) that include numerology (sub-carrier spacing) information.

A base station (gNB) 160 may send 1802 system information comprising information elements (IEs) of a list and/or instances for allowed/supported numerologies (sub-carrier spacing) in a cell for uplink (UL) frequencies and downlink (DL) frequencies, The IEs may be sent over dedicated RRC signaling and/or broadcast signaling.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A user equipment (UE), comprising:
a processor; and
memory in electronic communication with the processor, wherein instructions stored in the memory are executable to:
receive system information comprising information elements (IEs) of a list and/or instances for allowed/supported numerologies (sub-carrier spacing) in a cell for uplink (UL) frequencies and downlink (DL) frequencies, wherein the IEs are received over dedicated RRC signaling and/or broadcast signaling; and
configure or reconfigure the UE to send and receive packets using the allowed/supported numerologies (sub-carrier spacing).

2. The UE of claim 1, wherein the IEs of the list and/or instances for allowed/supported numerologies (sub-carrier spacing) comprise:
one or more supported/allowed instances numerologies (sub-carrier spacing) IE or numerology instances comprising 15 kilohertz (kHz), 30 kHz, 60 kHz, 120 kHz, or 240 kHz; and
a number of numerology (carrier spacing) supported/allowed IE, or a numerology (sub-carrier spacing) list comprising an integer number (1-N), wherein N is a maximum number of numerologies allowed/supported as configured by a base station (gNB).

3. The UE of claim 1, wherein the instructions stored in the memory are executable to:
receive an RRC message comprising information elements (IEs) comprising a list and/or instances of the allowed/supported numerologies (sub-carrier spacing) for configuration of one or more of the following:
a signaling radio bearer (SRB),
a data radio bearer (DRB), or
measurement configurations and a measurements report for inter/intra-frequency measurements comprising the allowed/supported list and/or instances of numerologies (sub-carrier spacing); and
configure or reconfigure the UE to send and receive packets using the indicated list and/or instances of the allowed/supported numerologies (sub-carrier spacing).

4. The UE of claim 3, wherein the UE performs measurements using the list and/or instances of supported/allowed numerology and reports these measurements as configured.

5. The UE of claim 3, wherein the RRC message comprises one or more of the following:
an RRCConnectionSteup message,
an RRCConnectionReconfiguration message,
an RRCConnectionResume message, or
an RRCConnectionRe-Establishment message.

6. The UE of claim 3, wherein the information elements (IEs) of the list and/or instances for allowed/supported numerologies (sub-carrier spacing) are included in one or more of the following radio resource control/configuration IEs:
a logical channel configuration IE,
a measurement configuration IE,
downlink and uplink frequency information IEs,
operational system bandwidth IEs, or
configured uplink grants IEs.

7. The UE of claim 1, wherein the allowed/supported numerology used for UL frequencies is configured for physical uplink control channel (PUCCH) and/or physical uplink shared channel (PUSCH), and wherein the allowed/supported numerology used for DL frequencies is configured for physical downlink control channel (PDCCH) and/or physical downlink shared channel (PDSCH).

8. A base station (gNB), comprising:
a processor; and
memory in electronic communication with the processor, wherein instructions stored in the memory are executable to:
send system information comprising information elements (IEs) of a list and/or instances for allowed/supported numerologies (sub-carrier spacing) in a cell for uplink (UL) frequencies and downlink (DL) frequencies, wherein the IEs are sent over dedicated RRC signaling and/or broadcast signaling.

9. The gNB of claim 8, wherein the IEs of the list and/or instances for allowed/supported numerologies (sub-carrier spacing) comprise:
one or more supported/allowed instances numerologies (sub-carrier spacing) IE or numerology instances comprising 15 kilohertz (kHz), 30 kHz, 60 kHz, 120 kHz, or 240 kHz; and
a number of numerology (carrier spacing) supported/allowed IE, or a numerology (sub-carrier spacing) list, comprising an integer number (1-N), wherein N is a maximum number of numerologies allowed/supported as configured by a base station (gNB).

10. The gNB of claim 8, wherein the instructions stored in the memory are executable to:
send an RRC message comprising information elements (IEs) comprising a list and/or instances of the allowed/supported numerologies (sub-carrier spacing) for configuration of one or more of the following:
a signaling radio bearer (SRB),
a data radio bearer (DRB), or
measurement configurations and a measurements report for inter/intra-frequency measurements comprising the allowed/supported list and/or instances of numerologies (sub-carrier spacing).

11. The gNB of claim 10, wherein a user equipment (UE) performs measurements using the list and/or instances of supported/allowed numerology and reports these measurements as configured.

12. The gNB of claim 10, wherein the RRC message comprises one or more of the following:
an RRCConnectionSteup message,
an RRCConnectionReconfiguration message,
an RRCConnectionResume message, or
an RRCConnectionRe-Establishment message.

13. The gNB of claim 10, wherein the information elements (IEs) of the list and/or instances for allowed/supported numerologies (sub-carrier spacing) are included in one or more of the following radio resource control/configuration IEs:
a logical channel configuration IE,
a measurement configuration IE,
downlink and uplink frequency information IEs,
operational system bandwidth IEs, or
configured uplink grants IEs.

14. The gNB of claim 8, wherein the allowed/supported numerology used for UL frequencies is configured for physical uplink control channel (PUCCH) and/or physical uplink shared channel (PUSCH), and wherein the allowed/supported numerology used for DL frequencies is configured for physical downlink control channel (PDCCH) and/or physical downlink shared channel (PDSCH).
